(19) United States
(12) Patent Application Publication
(10) Pub. No.: US 2004/0066809 A1
(43) Pub. Date: Apr. 8, 2004

(54) Optical resonator and wavenlength control module using the resonator

(76) Inventors: Hitoshi Oguri, Funabashi-shi (JP); Takeshi Sakai, Chiyoda-ku (JP); Yuhki Kinpara, Ichikawa-shi (JP); Hironori Tokita, Tokyo (JP)

Correspondence Address: OSTROLENK FABER GERB & SOFFEN, 1180 AVENUE OF THE AMERICAS, NEW YORK, NY, 100368403

(21) Appl. No.: 10/467,990

(22) PCT Filed: Feb. 19, 2002
(86) PCT No.: PCT/JP02/01421

(30) Foreign Application Priority Data
Feb. 20, 2001 (JP) 2001-44039
Feb. 20, 2001 (JP) 2001-44040
Mar. 8, 2001 (JP) 2001-65158
Mar. 14, 2001 (JP) 2001-72861
Jul. 19, 2001 (JP) 2001-219681
Aug. 3, 2001 (JP) 2001-236061

(51) Int. Cl. H01S 3/13

(52) U.S. Cl. 372/32

(57) ABSTRACT

There is provided an optical resonator having good temperature characteristics, allowing mass-production, and having excellent long-term stability, and an optical resonator which constitutes a wavelength control module capable of coping with an increase in density of wavelength interval. The optical resonator has two substrates having a specified reflectance, disposed oppositely and parallel to each other through a spacer, so that the reflection surfaces become inside. The spacer is made from a material having a coefficient of linear expansion of almost zero, formed in a block with a specified thickness, and having a hollow part penetrating in the thickness direction. The hollow part communicates with the outside through a groove part, and the two substrates are joined on opposite end faces of the spacer in the thickness direction.

### TECHNICAL FIELD

The present invention relates to an optical resonator and a wavelength control module using the resonator. More specifically, the present invention relates to a manufacturing method of the optical resonator, and the optical resonator and the wavelength control module, which can improve stability in the temperature characteristic and transmission characteristic at the time of operation, and detection accuracy of wavelength variation, and which is capable of corresponding to a reduction in wavelength intervals in wavelength control of the wavelength control module using this optical resonator and is further capable of miniaturization.

### BACKGROUND ART

In the wavelength-division multiplex mode (hereinafter referred to as “WDM” mode), an optical signal having a plurality of wavelengths is used, but when the density in wavelength interval of the used optical signal increases, the interval between the adjacent wavelengths decreases. In general, a semiconductor laser (LD) is used for the light source in the WDM mode, but with the LD, variation occurs in the central wavelength of the outgoing beam due to a change with the lapse of time, and the environment, and as a result crosstalk may occur with the adjacent wavelength to cause radio interference. Therefore, in order to keep the emission wavelength of the LD constant, for example, a wavelength control system using a wavelength control module as shown in FIG. 25 is used.

In FIG. 25, reference symbol 1 denotes an LD light source, and 11 denotes a wavelength control module. The LD light source 1 is constituted such that the emission wavelength can be controlled by controlling the chip temperature or the LD introduced current value. In the former case, a device, which controls the chip temperature, a temperature controller, a thermoelectric device (5) or introduced current control means (4) (not shown) is provided. The outgoing beam from the LD light source 1 is branched into two by an optical coupler 2. For example, by this first optical coupler 2, 95% of the outgoing beam enters a transmission optical fiber via an LN modulator 3, and the remaining 5% enters a wavelength control module 111 as a monitoring optical signal.

In the wavelength control module 11, at first the monitoring optical signal is input to a half mirror 13 as parallel light by a collimator 12. The transmitted light from the half mirror 13 enters an optical resonator 14, and the intensity of the transmitted light of the optical resonator 14 is measured by a first optical diode 15. On the other hand, the reflected light of the half mirror 13 is guided to a second optical diode 17 via a reflecting mirror 16, wherein the optical intensity thereof is measured.

In general, the collimator 12, the half mirror 13, the optical resonator 14, the first optical diode 15, the reflecting mirror 16 and the second optical diode 17 are fixed on a board or in a housing, which houses these collectively.

FIG. 26 is a cross section showing one example of the configuration of a (conventional optical resonator 14. This optical resonator 14 is constructed such that two substrates 21, 21′ respectively provided with a reflection coating 21a, 21b having a predetermined reflectivity on one plane, are arranged parallel with each other so as to face each other, with a medium 22 therebetween, and a spacer 23 is arranged between the two substrates 21 and 21′, so that the length d between the substrates 21 and 21′ (hereunder may be referred to as a cavity length) becomes a predetermined length. In this example, the medium 22 is an atmospheric layer.

The transmittance of light in the optical resonator 14 has wavelength dependency, and has a wavelength-transmittance characteristic close to a sine wave, for example, as shown in FIG. 28. Therefore, if the wavelength of the monitoring optical signal entering the optical resonator 14 is constant, the intensity of the transmitted light measured by the first optical diode 15 is constant, and when the wavelength of the monitoring optical signal changes, the change appears as a change in the intensity of the transmitted light measured by the first optical diode 15.

Moreover, the intensity of the outgoing beam from the LD light source 1 may change with lapse of time, and in this case, even if the wavelength of the outgoing beam is constant, the intensity of the transmitted light measured by the first optical diode 15 changes. Since a value obtained by measuring the intensity of the reflected light of the half mirror 13 by the second optical diode changes corresponding to the change in the intensity of the outgoing beam of the LD light source 1, this change can be cancelled by using a value of the optical intensity measured by the first optical diode and a value of the optical intensity measured by the second optical diode, to perform arithmetic processing so that the variation in the intensity of the transmitted light due to the change in the intensity of the outgoing beam is cancelled. Therefore, the wavelength control module can control the variation in the intensity of the transmitted light due to the wavelength change of the outgoing beam.

The temperature controller in the LD light source 1, or the LD introduced current value is controlled so that the wavelength of the outgoing beam is returned to the original wavelength, based on the variation in the intensity of the transmitted light after the arithmetic processing, that is, so that the variation in the intensity of the transmitted light after the arithmetic processing becomes substantially zero. Reference symbol 5 denotes an arithmetic unit, and 6 denotes a control unit in FIG. 25.

In order to cope with an increase in density of wavelength interval in the WDM mode, it becomes necessary to suppress the variation margin of the emission wavelength of the LD light source 1.

However, there is the temperature dependency in the characteristics of the optical resonator 14 constituting the wavelength control module 11, and this becomes one of the problems when it is attempted to control the emission wavelength of the LD light source 1 highly accurately to thereby decrease the variation margin thereof. There is a method in which a temperature change in the optical resonator 14 is detected by providing a temperature sensor 18 in the wavelength control module 11, and a circuit (not shown) for compensating the temperature based on the detection result is provided. With this method, however, the number of devices increases, and the circuit becomes more complicated, thereby causing problems in that the error may become big, and the apparatus becomes large, leading to a cost increase.

In order to control the emission wavelength of the LD light source 1 highly accurately, it is also necessary that the optical resonator 14 constituting the wavelength control module 11 be produced highly accurately. In order to increase the accuracy of the cavity length d however, the optical resonator has been heretofore assembled one by one, and hence, mass production is not possible, which causes cost increase as well.

Moreover, the wavelength control module 11 may be installed in a place where it is difficult to repair the module frequently, for example, underground or under the sea. Therefore, it is desired that the wavelength control module 11 have excellent long-term reliability, such that highly accurate measurement can be conducted stably over a long period of time.

It is therefore a first object of the present invention to provide a method of manufacturing an optical resonator and a wavelength control module having good temperature characteristics, allowing mass-production, and having excellent long-term stability.

Further, it is an important object in the development of the optical resonator and the wavelength control module, in conjunction with the manufacturing method of the optical resonator and the wavelength control module, to suppress a change in the emission wavelength of the LD light source. For that purpose, a second object is how to stabilize a change in the intensity of the transmitted light due to the change in the emission wavelength, including the improvement in the structure of the optical resonator. Specifically, the second object is as described below.

As described above, the transmittance of light of the optical resonator 14 in the wavelength control module shown in FIG. 25 has wavelength dependency, and has a wavelength-transmittance characteristic close to a sine wave, for example, as shown in FIG. 28. Therefore, if the wavelength of the monitoring optical signal entering the optical resonator 14 is constant, the intensity of the transmitted light measured by the first optical diode 15 is constant, and when the wavelength of the monitoring optical signal changes, the change appears as a change in the intensity of the transmitted light measured by the first optical diode 15.

On the other hand, the intensity of the outgoing beam from the LD light source 1 may change with lapse of time, and in this case, even if the wavelength of the outgoing beam is constant, the intensity of the transmitted light measured by the first optical diode 15 changes. As for this problem, if arithmetic processing is conducted so as to take a difference between a value of the optical intensity measured by the first optical diode and a value of the optical intensity measured by the second optical diode, then of the variations in the intensity of the transmitted light measured by the first optical diode 15, the variation in the intensity of the transmitted light due to the change in the intensity of the outgoing beam is compensated for, and hence the variation in the intensity of the transmitted light due to the wavelength change of the outgoing beam can be known. Moreover, the temperature controller in the LD light source 1 or the LD introduced current is controlled so that the wavelength of the outgoing beam is returned to the original wavelength, that is, the variation in the intensity of the transmitted light after the arithmetic processing becomes substantially zero, based on the variation in the intensity of the transmitted light after the arithmetic processing.

In order to cope with an increase in density of the wavelength interval in the WDM mode, it becomes necessary to suppress the variation margin of the emission wavelength of the LD light source 1. Therefore, it is desired to highly stabilize the transmission characteristic of the optical resonator 14, in order to improve the accuracy of the wavelength control module.

Therefore the second object of the present invention is to highly stabilize the transmission characteristic of the optical resonator constituting the wavelength control module, in order to further suppress the variation margin of the wavelength emitted from the LD light source.

On the other hand, as described above, in the development of the optical resonator and the wavelength control module, it is an important object for the manufacturing method and the upgrade of the performance of the optical resonator corresponding to the high density of the wavelength of laser beams, to develop an optical control module capable of measuring an intensity change of the outgoing beam of the optical resonator precisely. That is to say, it is a third object to obtain a wavelength control module which can measure the intensity of the outgoing beam highly accurately, so that there is no change in the intensity measurement of the outgoing beam, even if a geometrical direction of the outgoing beam changes slightly. In other words, it is recently desired to suppress the variation margin of the emission wavelength of the LD light source 1, in order to cope with an increase in density of the wavelength interval in the WDM mode. For that purpose, there is a problem of how to measure a change of the transmission intensity itself of the outgoing beam from the optical resonator due to the variation in the emission wavelength of the LD light source 1 in the wavelength control module 11 highly accurately, and the third object of the present invention is to solve this problem.

As described above, it is a fourth object to provide a wavelength control module capable of executing the wavelength control in the wavelength control module in a higher precision, in order to cope with an increase in density of the wavelength interval in the WDM mode, in the optical resonator and the wavelength control module.

Here, the relation between the transmission characteristic of the transmitted light of the LD light source in the optical resonator, and a cavity length of the optical resonator having an intimate relationship with an increase in density of the wavelength interval is studied.

As described above, the transmission characteristic of light from the optical resonator has wavelength dependency, and if this is expressed by a graph in which the wavelength is plotted on the X axis and the transmittance is plotted on the Y axis, a graph in which a mountain-shaped distribution of a certain shape as shown in FIG. 28 is continuous is obtained, wherein a peak of the transmittance appears for each constant wavelength interval.

The transmittance T (λ) (unit: %) of this optical resonator is expressed by the following equations (1), (2) and (3), with the wavelength being a function of λ (nm). In equation (1), TO denotes maximum transmittance (peak value in transmittance), n denotes a refractive index of the medium 22, d denotes a gap length, and θ denotes an incidence angle with respect to the substrate 21. When the reflectance of the two reflecting surfaces 21a and 21b is respectively expressed by R1 and R2, F is expressed by equation (2), and R in equation (2) is expressed by equation (3).

$$\begin{matrix}T ( λ ) = \frac{{T}_{0}}{1 + F {sin}^{2} ( 2 π nd cos θ / λ )} & ( 1 ) \\ F = \frac{4 R}{{( 1 - R )}^{2}} & ( 2 )\end{matrix}$$

R=\sqrt{(R₁×R₂)} (3)

Therefore, if the construction is such that the wavelength of the monitoring optical signal entering the optical resonator 14 becomes a wavelength shifted from the central wavelength (P1, P2, . . . ), for example, λ1, then, when the wavelength of the outgoing beam from the LD light source 1 changes from the wavelength λ1, the change appears as a change in the intensity of the transmitted light measured by the first optical diode 15.

Moreover, the intensity of the outgoing beam from the LD light source 1 may change with lapse of time, and in this case, even if the wavelength of the outgoing beam is kept constant, the intensity of the transmitted light measured by the first optical diode 15 changes. As for this problem, if arithmetic processing is conducted so as to take a difference between a value of the optical intensity measured by the first optical diode and a value of the optical intensity measured by the second optical diode, then of the variations in the intensity of the transmitted light measured by the first optical diode 15, the variation in the intensity of the transmitted light due to the change in the intensity of the outgoing beam is cancelled, and hence the variation in the intensity of the transmitted light due to the wavelength change of the outgoing beam can be known.

Moreover, the temperature controller in the LD light source 1 or the LD introduced current is controlled so that the wavelength of the outgoing beam is returned to the predetermined wavelength λ1, that is, the variation in the intensity of the transmitted light after the arithmetic processing becomes substantially zero, based on the variation in the intensity of the transmitted light after the arithmetic processing. The wavelength is controlled, by using the arithmetic unit 5 and the control unit 6 in the wavelength control module shown in FIG. 25.

Furthermore, optical signals having a plurality of wavelengths (λ1, λ2, λ3, . . . ) are used as the outgoing beams of the LD light source 1, and when the interval between the respective wavelengths is constant at Δλ, and if the wavelength interval AP between the central wavelengths P1, P2, . . . in the optical resonator 14 is equal to Δλ, the change in the intensity of the transmitted light with respect to the change in the outgoing beam of the LD light source 1 becomes the same, in any wavelength λ1, λ2, λ3 . . . . As a result, the outgoing beam having the plurality of wavelengths emitted from the LD light source 1 can be controlled to be constant, by using a common apparatus and system.

Recently, however, an increase in density of the wavelength interval is desired in the WDM mode, and the interval (Δλ) of the emission wavelength of the LD light source 1 tends to decrease further.

Therefore, in the conventional wavelength control module 11 shown in FIG. 25, when the wavelength interval (Δλ) of the optical signals having a plurality of wavelengths emitted from the LD light source 1 is reduced, it is necessary to reduce the interval ΔP of the central wavelengths in the optical resonator 14, and the cavity length d of the optical resonator 14 must be made long for that purpose. For example, when the interval (Δλ) of the emission wavelength of the LD light source 1 is made ½, the cavity length d must be twice the length in order to set the interval ΔP of the central wavelengths to ½. If the interval (Δλ) of the emission wavelength of the LD light source 1 becomes ¼, then the cavity length d must be four times.

However, when the cavity length d becomes long, the optical resonator 14 becomes large, and hence production thereof becomes difficult, causing a cost increase, and deteriorating the mass-productivity and reliability.

Therefore, in the wavelength control module using the optical resonator, it is an object to obtain a wavelength control module that can cope with an increase in density of the wavelength interval in the WDM mode.

In other words, it is a fourth object of the present invention to provide a wavelength control module that can cope with an increase in density of the wavelength interval in the WDM mode.

Moreover, an important object as well as the highly accurate control and highly accurate measurement of the transmitted light of the optical resonator, is to prevent the optical resonator from becoming large due to an increase in density of the wavelength interval, and to develop a small optical resonator that can cope with an increase in density of the wavelength interval, which is a fifth object of the present invention.

As described above, the wavelength control module tends to become large in order to cope with an increase in density of the wavelength interval in recent WDM methods. In other words, in the conventional wavelength control module 11, when the wavelength interval (Δλ) of the optical signals having a plurality of wavelengths emitted from the LD light source 1 is reduced, it is necessary to reduce the interval ΔP of the central wavelengths in the optical resonator 14, and the cavity length d of the optical resonator 14 must be made long for that purpose. That is, when the interval (Δλ) of the emission wavelength of the LD light source 1 is made ½, the cavity length d must be twice the length in order to set the interval ΔP of the central wavelengths to ½. If the interval (Δλ) of the emission wavelength of the LD light source 1 becomes ¼, then the cavity length d must be four times.

When the cavity length d becomes long, the optical resonator 14 becomes large, and hence the component parts of the wavelength control module 11 cannot be housed in the conventional housing or board, causing a problem in that the size of the wavelength control module 11 becomes large. As described above, it is a fifth object of the present invention to cope with an increase in density of the wavelength interval, and make the size of the optical resonator small.

### DISCLOSURE OF THE INVENTION

A first aspect of the present invention providing an optical resonator, a wavelength control module including the same, and a manufacturing method therefor.

A first feature of the first aspect is that the optical resonator of the present invention comprises: a spacer made from a material having a coefficient of linear expansion of almost zero, formed in a block with a specified thickness, and having a hollow part penetrating in the thickness direction, the hollow part communicating with the outside; and two substrates joined on opposite end faces of the spacer in the thickness direction, and a reflecting coating is provided at least on an area facing the inside of the hollow part, of the opposing faces of the two substrates.

A second feature is that in the optical resonator, the substrates and the spacer are joined by optical contact, and a third feature is that in order to realize the optical contact, a profile irregularity on the joined faces of the substrate and the spacer is respectively ¼, in the joint portion of the substrate and the spacer.

A fourth feature is that the thickness of the spacer is constant in the optical resonator. A fifth feature is that the hollow part is filled with dry nitrogen or dry air, in the optical resonator.

A sixth feature is that the wavelength control module of the present invention comprises: the optical resonator; a device which inputs a monitoring optical signal to one substrate of the optical resonator as parallel light; a device which detects a change in the intensity of the transmitted light emitted from the other substrate of the optical resonator; and a sealable housing which houses at least the optical resonator.

A seventh feature is that the wavelength control module is characterized in that an optical path from the input device, passing through the optical resonator and reaching the detection device is housed in the housing. An eighth feature is that in the wavelength control module, the inside of the housing is replaced by dry nitrogen or dry air.

As a ninth feature, the manufacturing method of the optical resonator according to the present invention is disclosed. The manufacturing method is a method of manufacturing an optical resonator in which two substrates arranged so as to face each other are joined on the opposite end faces of a spacer in the thickness direction, which has a hollow part penetrating in the thickness direction and is formed in a block, and a reflecting coating is provided at least on an area facing the inside of the hollow part, of the opposing faces of the two substrates, characterized by having a process for forming the spacer by cutting a spacer base material formed in a plate form with a predetermined thickness, and having a plurality of hollow parts formed therein penetrating in the thickness direction, with adjacent hollow parts communicating with each other, in the thickness direction between the adjacent hollow parts.

A tenth feature is that in the above manufacturing method, in order to obtain the optical resonator in which the substrates and the spacer are joined with optical contact, the manufacturing method comprises: before cutting the spacer base material, a step for polishing the opposite end faces in the thickness direction of the spacer base material to adjust the surface roughness and flatness so that the profile irregularity becomes ¼; a step for cutting a substrate base material, in which one surface is polished to have the profile irregularity of ¼ or below, and a reflecting coating is formed on a part of the surface or over the whole surface, to thereby form the substrate; and a step for making the two substrates face each other so that the reflecting coating becomes inside, putting the spacer between these substrates and integrating the substrates and the spacer with optical contact.

An eleventh feature is a method of obtaining the optical resonator by: making two substrate base materials having a specified reflectance face each other so that the reflecting face becomes inside; obtaining a laminated body by putting the spacer base material between the substrate base materials; and then cutting the laminated body in the thickness direction between the adjacent hollow parts of the spacer base material. Particularly, in order to obtain the optical resonator in which the substrates and the spacer are joined with optical contact, a method is preferable, comprising: a step for polishing the opposite end faces of the spacer base material in the thickness direction so as to have a profile irregularity of ¼ or below before forming the laminated body; and a step for polishing one surface, of the inner surfaces of the two substrate base materials, so as to have a profile irregularity of ¼ or below before forming the reflecting coating.

A twelfth feature is a method for integrating the substrate base material and the spacer base material with optical contact before forming the laminated body, and a thirteenth aspect is that the manufacturing method comprises a step for replacing the inside of the hollow part with dry nitrogen or dry air.

According to the above-described configuration, the temperature characteristic of the optical resonator can be improved by constituting the spacer in the optical resonator by a material having a coefficient of linear expansion of almost zero.

The temperature characteristic of the optical resonator can be improved also by keeping a refractive index of the medium existing between the two substrates, that is, the refractive index in the hollow part of the spacer constant. Specifically, at the time of constructing the wavelength control module, at least the optical resonator is housed within a sealed housing, so that a change in density in the hollow part of the spacer is eliminated, thereby enabling the refractive index in the hollow part to be kept constant.

For example, an optical resonator as shown in FIG. 26, obtained by arranging two substrates 21, 21′ having a specified reflectance, parallel with each other, so that the reflecting surfaces (reflecting coatings 21a, 21b) thereof face each other, with a medium 22 therebetween, and intervening a spacer between the two substrates 21 and 21′, has the transmission characteristic as shown in FIG. 28, as described above, wherein a peak of transmittance appears in each constant wavelength interval. In this example, it is assumed that the reflectance of the reflecting coatings 21a and 21b is 90%.

As shown in FIG. 28, the transmittance T (λ) (unit: %) when the wavelength is λ (nm), is expressed by the above equation (1).

When the air temperature of the optical resonator 14 changes, thermal expansion may occur in the spacer 23, so that the cavity length d may change. According to the basic equation (1), it can be seen that even if the wavelength is constant, if the cavity length d changes, the transmittance also changes. Therefore, variation in the cavity length d accompanying the temperature change can be prevented by forming the spacer with a material having almost zero coefficient of linear expansion, thereby stabilizing the transmission characteristic of the optical resonator 14.

Preferably the material constituting the spacer 23 has a coefficient of linear expansion as close to zero as possible. The allowable range of the coefficient of linear expansion may be within a range of from about −0.02×10⁻⁶/K to +0.02×⁻⁶/K, though it depends on the stability level of the temperature characteristic to be obtained. A specific example of the material constituting the spacer having a coefficient of linear expansion of almost zero includes Zerodur (trademark), ULE (trademark) and the like.

The central wavelength changes due to a change in the refractive index n of the medium 22 caused by a change in the air temperature of the optical resonator 14 (see equation (1)). This is because, for example, if the temperature rises, the volume of the medium 22 increases, to decrease the density. If the density of the medium 22 decreases, the refractive index n decreases. As is seen from the basic equation (1), if the refractive index n of the medium 22 changes, the transmittance also changes, so that the central wavelength drifts. Therefore, if the optical resonator is constructed such that even if the air temperature changes, the refractive index n of the medium 22 does not change, the transmission characteristic of the optical resonator can be stabilized.

In order to keep the refractive index n of the medium 22 constant at all times, the density of the medium 22 need only to be kept constant at all times. When the medium 22 is a gas such as an atmospheric layer, the density of the medium 22 can be kept constant at all times by housing at least the optical resonator 14 in a sealed housing.

As described above, by making the medium 22 in the optical resonator 14 a sealed system, the density can be kept constant, though the pressure of the medium 22 changes when the environmental temperature changes, and hence the refractive index n can be kept constant. It is more preferable to house the optical path through which the monitoring optical signal emitted from the collimator 12 (input device) reaches the detection device, that is, in the illustrated example, the first and second optical diodes 15 and 17, within a sealed housing.

Moreover, as a result of an earnest study conducted by the present inventors, it has been found that if an adhesive is used for joining the substrates 21 and 21′ with the spacer 23, the transmission characteristic of the optical resonator 14 may become unstable due to the thermal expansion of the adhesive layer.

In other words, the coefficient of linear expansion of the adhesive is generally larger than that of a glass substrate, and it is difficult to control the thickness of the adhesive layer intervened between the substrates 21 and 21′ and the spacer 23, thereby causing a difference of from about 1 to 15 μm. Therefore, when the air temperature in the optical resonator 14 changes, thermal expansion occurs in the adhesive layer intervened between the substrates 21 and 21′ and the spacer 23, to cause a change in the cavity length d. As a result, the central wavelength in the transmission characteristic of the optical resonator 14 changes. Moreover, there is a difference in the variation margin thereof.

In the present invention, since an adverse effect due to the thermal expansion of the adhesive layer can be eliminated by joining the substrates 21 and 21′ and the spacer 23 by optical contact without using the adhesive, the temperature characteristic of the optical resonator 14 can be further improved.

Specifically, in order to realize the optical contact, it is preferable that the joint surfaces of the substrates 21, 21′ and the joint surface of the spacer 23 have a profile irregularity of not larger than ¼, respectively. Moreover, in the joint portion of the substrates 21, 21′ and the spacer 23, even if the reflecting coatings 21a and 21b exist between the substrates 21, 21′ and the spacer 23, the thickness of the reflecting coatings 21 a and 21b is as thin as about 1 to 7 μm. Therefore, by forming the joint surfaces of the substrates 21, 21′ and the joint surface of the spacer 23 so as to have the profile irregularity of not larger than ¼, the substrates 21, 21′ and the spacer 23 can be joined with optical contact, with the reflecting coatings 21a and 21b therebetween.

Here, the optical contact is a method for bonding planes with each other by direct contact without putting an adhesive layer therebetween, by sufficiently increasing the smoothness of the planes to be bonded. It is considered that both planes are bonded by van der Waals attraction.

The value of profile irregularity in the present invention is a value which becomes an index for the smoothness of the plane, and is a value obtained based on observation of interference fringes. It shows that as the value becomes smaller, the profile irregularity becomes higher.

According to the present invention, the joint area of the spacer and the substrates can be increased, by constructing the optical resonator by forming the spacer in a block form, and joining two substrates on the opposite end faces thereof in the thickness direction, respectively, and hence the strength and the stability of the joint portion can be improved.

Moreover, a pressure difference occurring between the inside (hollow part) and the outside of the optical resonator can be prevented by allowing the hollow part of the spacer to communicate with the outside. As a result, damage of the joint between the spacer and the substrates due to a stress resulting from an increase in the inner pressure in the hollow part can be prevented, thereby improving the long-term reliability of the optical resonator.

Furthermore, if the hollow part is filled with dry nitrogen or dry air, then particularly when the spacer and the substrates are joined by an adhesive, deterioration of the adhesive due to a contact with moisture can be suppressed.

More preferably, when the wavelength control module is constructed by using this optical resonator, if at least the optical resonator is housed in a sealed housing, and the inside of this housing is replaced by dry nitrogen or dry air, contact with moisture outside of the optical resonator can be eliminated. As a result, dew formation in the module can be prevented, and especially when the spacer and the substrates are joined by an adhesive, deterioration of the adhesive due to the contact with the moisture can be more reliably prevented.

In the optical resonator of the present invention, since the spacer is formed in a block form, spacers can be easily mass-produced with high thickness accuracy, by a method for cutting a plate-form spacer base material which is controlled to a specified thickness.

Moreover, an optical resonator having high shape accuracy can be manufactured with good productivity, by using a method in which, after a laminated body is obtained by using a large substrate base material and putting the spacer base material between two substrate base materials, the laminated body is cut to obtain the optical resonator.

According to a second aspect of the present invention, there is provided means for solving the second problem, that is, for stabilizing the transmitted light of the optical resonator. For example, the optical resonator 14 having the configuration shown in FIG. 22 has a transmission characteristic as shown in FIG. 28, and has a peak of the transmittance in each constant wavelength interval. The transmittance T (λ) (unit: %) when the wavelength is λ (nm), is expressed by the above described equations (1), (2) and (3).

As the factors causing variations in the characteristics of the optical resonator 14, for example, there can be mentioned a deviation of a fixed position of each element in the optical resonator 14, due to a difference in the coefficient of linear expansion of the housing, the adhesive, and each member of the optical resonator. For example, when a shift occurs such that a displacement occurs when observing the optical resonator 14 from above, designating the incident direction of light as a horizontal direction, because the optical resonator 14 shifts in a rotation direction as shown by an arrow P in FIG. 27, the incident angle θ with respect to the substrate 21 changes. As a result, as is seen from the above equation (1), even if the wavelength is constant, the transmittance of the optical resonator 14 changes, thereby causing a drift in the transmission wavelength. Therefore, the transmission characteristic of the optical resonator can be stabilized by suppressing the variation in the incident angle θ.

When the air temperature of the optical resonator 14 changes, thermal expansion may occur in the spacer 23, so that the cavity length d may change. According to equation (1), it can be seen that even if the wavelength is constant, if the cavity length d changes, the transmittance also changes. Therefore, the transmission characteristic of the optical resonator 14 can be stabilized by suppressing such variation in the cavity length d.

The refractive index n of the medium 22 may change due to a change in the air temperature of the optical resonator 14. For example, if the temperature rises, the volume of the medium 22 increases, to decrease the density. If the density of the medium 22 decreases, the refractive index n decreases. As is seen from equation (1), if the refractive index n of the medium 22 changes, the transmittance also changes, so that the central wavelength drifts. Therefore, when the optical resonator is constructed such that even if the air temperature changes, the refractive index n of the medium 22 does not change, the transmission characteristic of the optical resonator can be stabilized.

As described above, the means for solving the second problem of the present invention for further stabilizing the transmission characteristic of the optical resonator 14 is a wavelength control module comprising: an optical resonator obtained by arranging two substrates, whose one face is a reflecting surface having a specified reflectance, parallel with each other so that the reflecting surfaces face each other with the medium therebetween, and intervening a spacer between the two substrates; a device which inputs a monitoring optical signal to the optical resonator as parallel light; and a device which detects a change in the intensity of the transmitted light from the optical resonator, wherein the optical path from the input device, passing through the optical resonator and reaching the detection device is housed in a housing, and the optical resonator is fixed on the inner face of the housing, characterized in that a fixing member for suppressing movement of the optical resonator is provided on the inner face of the housing.

Secondly, a concave portion for suppressing the movement of the optical resonator is provided on the inner face of the housing.

Thirdly, when a fixing member is provided, then preferably only one substrate of the components of the optical resonator is fixed by bonding to the housing and/or the fixing member. A resilient member is used as the means for fixing the optical resonator to the housing and/or the fixing member.

Fourthly, when a concave portion is provided, it is desired that only one substrate of the components of the optical resonator is fixed by bonding with the housing and/or the concave portion. A resilient member may be used as a means for fixing the optical resonator to the housing and/or the concave portion.

Fifthly, it is preferable that the spacer is formed from a material having a coefficient of linear expansion of almost zero, and the housing is sealed.

If the movement of the optical resonator is suppressed, and the spacer is formed from a material having a coefficient of linear expansion of almost zero, variation in the gap length d accompanying a temperature change can be prevented. Moreover, if the housing which houses the optical resonator is a sealed system, then, even if the pressure of the medium in the optical resonator changes when the environmental temperature changes, the density is kept constant, so that variation in the refractive index n accompanying the temperature change can be suppressed. As a result, the transmission characteristic of the optical resonator can be further stabilized.

According to a third aspect of the present invention, there is provided a wavelength control module that can measure the intensity of the transmitted light emitted from the optical resonator with high accuracy, which is the third object. In other words, for example, when the ambient temperature changes, a deviation occurs in the position where the optical resonator 14 is fixed due to a difference in the coefficient of linear expansion of the housing, the adhesive, and each member of the optical resonator, and variation may occur in the intensity of the transmitted light measured by the first optical diode 15 resulting from this deviation. Therefore, it is considered necessary to prevent the occurrence of error in the measurement of the intensity of the transmitted light due to this deviation of the optical axis of the output light of the optical resonator.

FIG. 27 is a cross section of the optical resonator 14 as seen from the above, whose bottom face is fixed. For example, when the optical resonator 14 shifts, such that the optical resonator 14 slightly rotates in a direction shown by an arrow P in the figure, the incident angle θ of the monitoring optical signal with respect to the substrate 21 changes, and variation may occur in the intensity of the transmitted light measured by the first optical diode 15 (detection device) due to the change.

In other words, the incident angle of the monitoring optical signal with respect to the substrate 21 is normally set to θ1, and the optical resonator is constructed such that on the first optical diode 15, as shown in FIG. 25, the whole of the irradiation area irradiated with the transmitted light of the optical resonator 14 is included in a detectable area (in this specification, referred to as a detection area) on a light-receiving plane of the first optical diode 15.

However, when the incident angle of the monitoring optical signal with respect to the substrate 21 changes to θ2, due to a slight rotation of the optical resonator 14 in the direction shown by arrow P, for example as shown by the solid line in FIG. 27, the optical path in the medium 22 of the optical resonator 14 changes, and as a result, the position where the transmitted light is emitted in the optical resonator 14 changes. Therefore, in the first optical diode 15, as shown in FIG. 25, a part of the irradiation area 30 of the transmitted light may be outside of the detection area 15a. In this case, since the intensity of the transmitted light measured by the first optical diode 15 is measured to be a lower value by the portion that a part of the irradiation area 30 of the transmitted light deviates from the detection area 15a of the first optical diode 15, then even if the emission wavelength of the LD light source 1 is constant, the intensity of the transmitted light measured by the first optical diode 15 changes. As a result, false-recognition occurs such that there is a wavelength change in the monitoring optical signal.

In order to solve this problem, the wavelength control module comprises: an optical resonator obtained by arranging two substrates, whose one face is a reflecting surface having a specified reflectance, parallel with each other so that the reflecting surfaces face each other with the medium therebetween; a device which inputs a monitoring optical signal to the optical resonator as parallel light, and a device which detects a change in the intensity of the transmitted light from the optical resonator, wherein a condensing device which condenses the transmitted light emitted from the optical resonator to a detection area of the detection device is provided between the optical resonator and the detection device.

Secondly, an area of an irradiation area of the transmitted light irradiated to the detection device is smaller than that of the detection area. Thirdly, for example, the area of the irradiation area is not larger than ½ of the area of the detection area.

Fourthly, for the condensing device, a condensing lens can be preferably used. Fifthly, for example, a condensing lens having a focal length of from 1.8 to 4.0 mm is used for the condensing device.

As described above, in the wavelength control module, a measurement error of the intensity of the transmitted light accompanying the deviation of the optical axis of the optical resonator can be prevented, by arranging the condensing lens for condensing the outgoing beam from the optical resonator to the detection area of the detection device, between the optical resonator and the detection device. As a result, detection accuracy for detecting the variation in the emission wavelength of the LD light source can be improved.

According to a fourth aspect of the present invention, there is provided means for solving the fourth problem, that is, a wavelength control module capable of coping with an increase in density of the wavelength interval in the WDM mode.

The wavelength control module in the fourth aspect for solving the fourth problem is a wavelength control module which controls an oscillating light source of a monitoring optical signal, so that an intensity of transmitted light of an optical resonator becomes substantially constant, when a monitoring optical signal having a wavelength deviated from the central wavelength at which there is a peak of transmittance is input to the optical resonator having a transmission characteristic such that, when wavelength is plotted on the X axis and transmittance is plotted on the Y axis, it shows a graph in which a mountain-shaped distribution of a certain shape is continuous. As the wavelength of the monitoring optical signal, both of a first wavelength on the shorter wavelength side than the central wavelength, and a second wavelength on the longer wavelength side than the central wavelength are used in the wavelength range forming the mountain-shaped distribution.

Secondly, an inclination of the graph in the first wavelength and an inclination of the graph in the second wavelength have an opposite sign and an equal absolute value.

Thirdly, in the wavelength control module, when a wavelength interval between the central wavelength in one mountain-shaped distribution and the central wavelength in another mountain-shaped distribution adjacent thereto is assumed to be ΔP, then in the wavelength control module, the wavelength interval between the first wavelength and the second wavelength is equal to ΔP/2.

Fourthly, the wavelength control module comprises; a device which detects a variation in the intensity of the transmitted light of the optical resonator, and a correction device which reverses a sign with respect to either one of the variation in the intensity of the transmitted light when the wavelength of the monitoring optical signal is the first wavelength, and the variation in the intensity of the transmitted light when the wavelength of the monitoring optical signal is the second wavelength.

Fifthly, the optical resonator is an optical resonator which shows a graph in which a mountain-shaped distribution of a certain shape is continuous, when the transmission characteristic of the optical resonator is expressed by a graph in which wavelength is plotted on the X axis and transmittance is plotted on the Y axis, wherein when a wavelength interval between the central wavelength in one mountain-shaped distribution at which the transmittance shows a peak and the central wavelength in another mountain-shaped distribution adjacent thereto is assumed to be ΔP, then in the wavelength range forming one mountain-shaped distribution, an inclination of the graph in the first wavelength on the shorter wavelength side than the central wavelength, and an inclination of the graph in the second wavelength on the longer wavelength side than the first wavelength by ΔP/2, have an opposite sign but the same absolute value.

Sixthly, the wavelength interval between the first wavelength and the second wavelength in one mountain-shaped distribution corresponds to a full width at half maximum.

Seventhly, the preferable configuration of the wavelength control module comprises: the optical resonator of the present invention; a device which inputs a monitoring optical signal having the first wavelength and a monitoring optical signal having the second wavelength to the optical resonator; a device which detects a variation in the intensity of transmitted light from the optical resonator; a correction device which reverses a sign with respect to either one of the variation in the intensity of the transmitted light when the wavelength of the monitoring optical signal is the first wavelength, and the variation in the intensity of the transmitted light when the wavelength of the monitoring optical signal is the second wavelength; and a device which controls the oscillating light source for the monitoring optical signal so that the detection results obtained through the correction device become substantially constant.

By constructing the optical resonator and the wavelength control module as described above, wavelength control can be carried out with high sensitivity, using an optical resonator having high reliability at low cost, without causing enlargement of the optical resonator, with respect to densification of the wavelength interval in the WDM mode.

According to a fifth aspect of the present invention, there is provided fifth means for constructing the optical resonator of a small size and capable of coping with an increase in density of the wavelength interval.

The first feature of the optical resonator in this aspect is that two substrates are arranged so as to face each other, with a medium therebetween, and in the optical resonator, inside end faces of the two substrates have a specified reflectance, respectively, and an outside end face of one substrate has an optical function as a half mirror.

According to this configuration, since the end face of the optical resonator has the optical function as a half mirror, then by using this end face as a plane of incidence it is not necessary to provide a half mirror, which has heretofore been arranged on the incident side of the optical resonator. As a result, the number of parts can be reduced, thereby achieving small size and low cost. Moreover, at the time of assembling the wavelength control module, fine adjustment has heretofore been necessary in order to arrange the half mirror and the optical resonator at optically appropriate positions. In the wavelength control module of the present invention however, it is not necessary to provide the half mirror in the previous stage of the optical resonator, and hence such fine adjustment is not required, thereby reducing the workload at the time of assembly. As a result, low cost can be further achieved.

A second feature is that in the optical resonator in which the outside end face of one substrate inclines with respect to the outside end face of the other substrate, a semitransparent film is formed on the outside end face of the one substrate.

According to this configuration, since the end face of the optical resonator has the optical function as the half mirror, then by using this end face as a plane of incidence it is not necessary to provide a half mirror, which has heretofore been arranged on the incident side of the optical resonator. As a result, the number of parts can be reduced, thereby achieving small size and low cost.

A third feature is that the wavelength control module comprises: the optical resonator; a device which inputs a monitoring optical signal to the outside end face of the one substrate in the optical resonator as parallel light; a first measurement device which measures the intensity of the transmitted light emitted from the outside end face of the other substrate in the optical resonator; and a second measurement device which measures the intensity of the reflected light reflected by the outside end face of the one substrate.

According to this configuration, since the end face of the optical resonator has the optical function as the half mirror, then by using this end face as a plane of incidence it is not necessary to provide a half mirror, which has heretofore been arranged on the incident side of the optical resonator. As a result, the number of parts can be reduced, thereby achieving small size and low cost.

Accordingly, even if the cavity length d of the optical resonator increases in order to cope with an increase in density of the wavelength interval in the WDM mode, so that the optical resonator becomes large, the components of the wavelength control module can be housed in a housing or a board of the same size as before, or of a smaller size than before.

### BRIEF DESCRIPTION OF THE DRAWING

FIGS. 1A and 1B are diagrams showing a first aspect of the optical resonator of the present invention.

FIG. 2 is a diagram showing an aspect (Example 1) of a manufacturing method for the optical resonator in FIG. 1.

FIG. 3 is a graph showing the result of test examples (Test Examples 1 and 2) relating to the temperature characteristic of the wavelength control module according to the first aspect of the present invention.

FIG. 4 is a graph showing the result of test examples (Test Examples 3 and 4) relating to the temperature characteristic of the wavelength control module according to the first aspect of the present invention.

FIG. 5 is a perspective view showing a modified example of the optical resonator according to the first aspect of the present invention.

FIG. 6 is a cross-sectional view of the modified example of the optical resonator shown in FIG. 5 according to the first aspect of the present invention.

FIG. 7 is a cross-sectional view showing another configuration example of the optical resonator according to the first aspect of the present invention.

FIGS. 8A and 8B are perspective views showing a first manufacturing method of the optical resonator according to the first aspect of the present invention.

FIGS. 9A and 9B are perspective views for explaining an example of a third manufacturing method for the optical resonator.

FIG. 10 is a graph showing the result of a test example (Test Example 5) relating to the temperature characteristic of the wavelength control module according to the first aspect of the present invention.

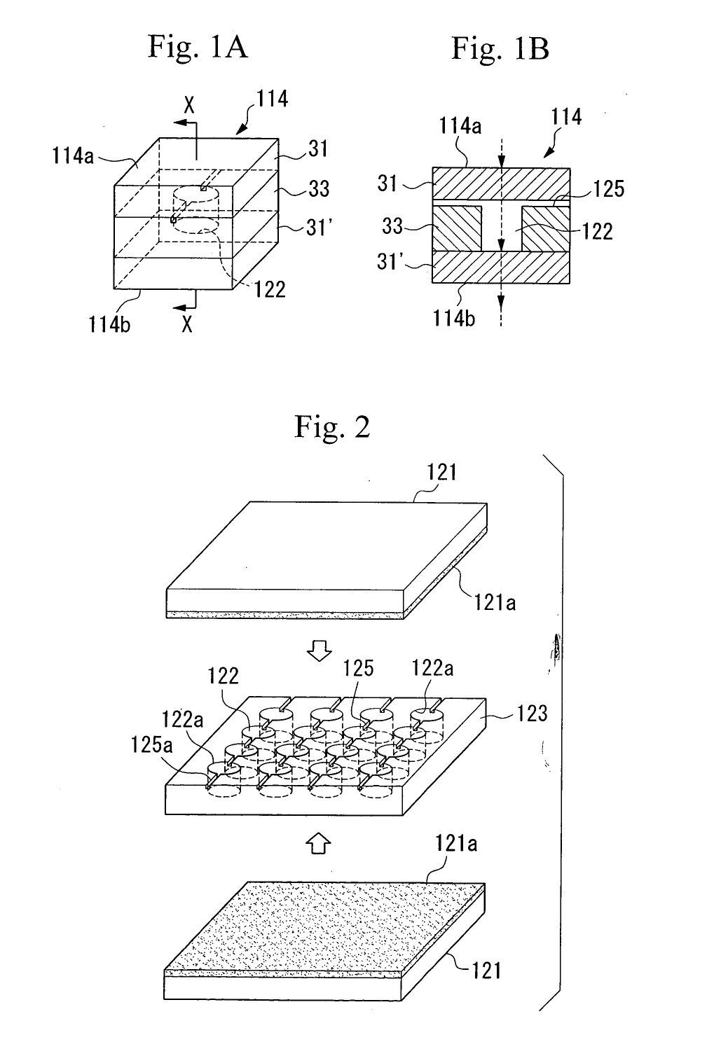

FIGS. 1A and 1B ((2)-1) show the configuration of the first example of the optical resonator in which misregistration is prevented, wherein 11A is a perspective view, and 11B is a plan view according to the second aspect of the present invention.

FIGS. 12A and 12B show the configuration of the optical resonator according to the second aspect of the present invention, in which misregistration is prevented, wherein 12A is a perspective view, and 12B is a plan view.

FIG. 13 is a graph showing test results (Test Examples 6 and 7) relating to the temperature characteristic of the wavelength control module according to the second aspect of the present invention.

FIG. 14 is a graph showing test results (Test Examples 8 and 9) relating to the temperature characteristic of the wavelength control module according to the second aspect of the present invention.

FIG. 15 shows a schematic configuration of a wavelength control system for an LD light source according to the third aspect of the present invention.

FIGS. 16A and 16B are diagrams showing a light-receiving plane of a first optical diode, wherein FIG. 16A is a diagram showing the normal state, and FIG. 16B is a diagram for explaining the state in which misregistration of the optical resonator occurs.

FIG. 17 shows test results (Test Examples 10 and 11) showing the temperature characteristic of the wavelength control module according to the third aspect of the present invention.

FIG. 18 is a graph showing test results (Test Examples 10 and 11) showing the temperature characteristic of the wavelength control module according to the third aspect of the present invention.

FIG. 19 is a schematic block diagram showing an example of the wavelength control system for an LD light source according to the fourth aspect of the present invention.

FIG. 20 shows the transmission characteristic of the optical resonator according to the fourth aspect of the present invention.

FIG. 21 shows the transmission characteristic of the optical resonator according to the fourth aspect of the present invention.

FIG. 22 shows a schematic configuration of the wavelength control module according to the fifth aspect of the present invention.

FIG. 23 is a diagram showing a first embodiment of the optical resonator used in the fifth aspect of the present invention.

FIG. 24 is a diagram showing a second embodiment of the optical resonator used in the fifth aspect of the present invention.

FIG. 25 is a schematic block diagram showing a conventional wavelength control system for the LD light source.

FIG. 26 is a schematic block diagram showing a schematic configuration of a conventional optical resonator.

FIG. 27 is a diagram for explaining misregistration of the optical resonator.

FIG. 28 is a graph showing the transmission characteristic in the optical resonator.

### DETAILED DESCRIPTION OF THE INVENTION

Various aspects relating to the configuration of the wavelength control module, particularly, the optical resonator, and the manufacturing method therefor according to the present invention will be described, with reference to the drawings. However, the present invention is not limited to these aspects described below, and for example, the configuration of the wavelength control module or the optical resonator in each aspect or the manufacturing method may be appropriately combined.

A new configuration of the wavelength control module, particularly, the optical resonator, and the manufacturing method therefor, being the first aspect of the present invention, will be described below.

In the configuration of the wavelength control module and the optical resonator and the manufacturing method therefor in a first embodiment of a first aspect, the wavelength control module has a configuration approximate to that of the conventional wavelength control module 11 shown in FIG. 25, but a different point from that of the conventional wavelength control module 11 is that an optical resonator 114 shown in FIG. 1 is used as the optical resonator, that an optical path from the collimator 12 (input device), passing through the optical resonator 114 and reaching the first optical diode 15 (detection device), and an optical path from the collimator 12, reflected by the half mirror 13 and reaching the second optical diode 17 are housed in a sealed housing (not shown), and that the inside of the housing is replaced by dry nitrogen or dry air.

The optical resonator 114 in the first embodiment of the first aspect will be described, with reference to FIGS. 1A and 1B.

FIG. 1A is a perspective view of the optical resonator, and FIG. 1B is a cross section along a line X-X. As shown in FIG. 1, this optical resonator 114 is obtained by laminating two substrates 31, 31′having a reflecting coating (not shown), on the opposite end faces of a spacer 33 in a block form in the thickness direction, so that the reflecting coating becomes inside, and fixing the substrates by bonding. A hollow part 122 penetrating the spacer 33 in the thickness direction is formed in the spacer 33, and the hollow part 122 communicates with the outside through a groove 125. The reflectance of the reflecting coatings of the two substrates 31, 31′ is set generally in a range of from 40 to 90%.

The spacer 33 is formed from a material having a coefficient of linear expansion of almost zero, such as Zerodur (trademark) and ULE (trademark).

As shown in FIG. 1, the spacer 33 in the first embodiment has a rectangular shape as a whole, and the hollow part 122 is formed in a cylindrical shape, but the shape of the cross section of the hollow part 122 can be changed. The overall shape can be changed to an appropriate shape so long as it has a constant thickness and the opposite ends are parallel with each other.

In this embodiment, two grooves 125 are formed for one hollow part 122, but it is only necessary that one hollow part 122 communicates with the outside at least at one point, and the hollow part 122 may communicate with the outside at three or more points. Moreover, in this embodiment, the groove 125 is provided on the front face of the spacer 33, but the groove 125 may be provided on the rear face thereof, or may be provided on both of the front face and the rear face. Furthermore, a tunnel (not shown) penetrating the peripheral wall of the spacer 33 may be provided instead of the groove 125. If a tunnel is provided instead of the groove 125, it is possible to increase the hole without decreasing the joint area between the spacer 33 and the substrates 31, 31′.

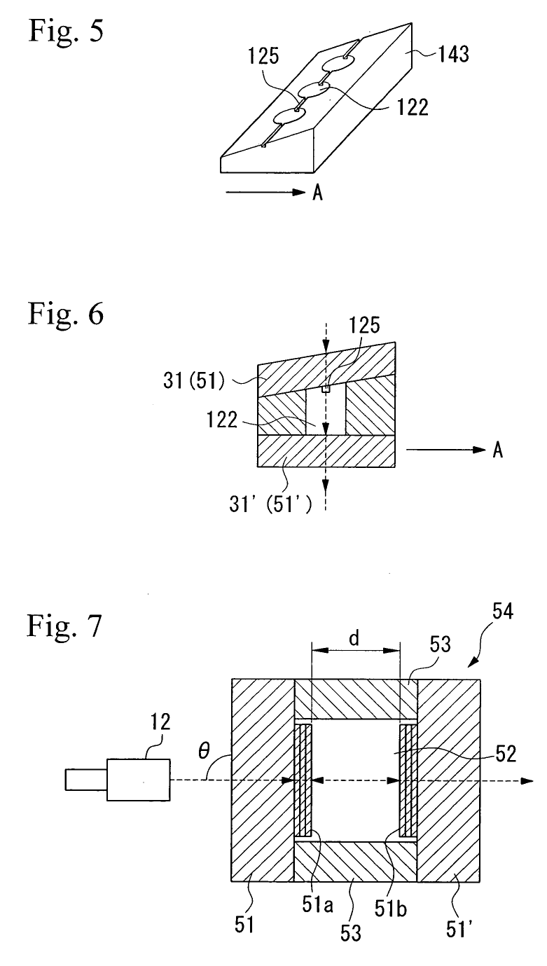

In the optical resonator 114 in the first embodiment, the opposite end faces 114a and 114b perpendicular to the thickness direction (lamination direction) become a plane of incidence and an outgoing plane of the light, respectively, the inside of the hollow part 122 becomes the medium, and the thickness direction (lamination direction) becomes the traveling direction of light as shown by the broken line in FIG. 5B.

The optical resonator in the first example of this embodiment can be manufactured by, for example, the following method. FIG. 2 illustrates the method of manufacturing the optical resonator in this embodiment.

At first, two substrate base materials 121 having a size of a plurality of substrates, each constituting one optical resonator, are prepared. On one surface of the substrate base material 121, a reflecting coating 121a is formed in advance on the whole surface.

On the other hand, a spacer base material 123 of the same size as the substrate base material 121 is prepared. This spacer base material 123 is a plate form with a constant thickness, and the front face and the rear face are parallel with each other. A plurality of hollow parts 122 penetrating the spacer base material 123 in the thickness direction is formed in the spacer base material 123. Preferably the hollow parts 122 are formed so as to be arrayed in a matrix with a predetermined interval, when the spacer base material 123 is seen in plan view.

Grooves 125 allowing the adjacent hollow parts 122 to communicate with each other are provided on the front face of the spacer base material 123, and the outermost hollow parts 122a communicate with the outside by the grooves 125a which open to the end face of the spacer base material 123.

Next the two substrate base materials 121 are made to face each other, so that the reflecting coatings 121a become the inside, and the spacer base material 123 is sandwiched between these base materials 121 and these are integrated. Specifically, an adhesive is applied on the front face and the rear face of the spacer base material 123, the substrate base materials 121 are overlapped thereon so that the reflective coating 121a become in contact with the spacer base material 123, and these are fixed by bonding, to thereby obtain a laminated body.

Thereafter, the obtained laminated body is cut in the thickness direction between the adjacent hollow parts 122, and is separated for each hollow part 122, so that the optical resonator 114 as shown in FIG. 1 is obtained.

In this embodiment, since the hollow parts 122 are arrayed in a matrix with a predetermined interval in the spacer base material 123, then by cutting the laminated body in a lattice form, the rectangular optical resonator 114 having one hollow part 122 at the center can be cut out in a plurality of numbers in the same size.

Since the optical resonator 114 in the first example in this embodiment is formed from a material having a coefficient of linear expansion of almost zero, the size variation due to the temperature change is small, with excellent temperature characteristic. Moreover, since the spacer 33 is formed in a block, and the two substrates 31, 31′ are respectively joined on the opposite end faces of the spacer 33 in the thickness direction, the joint area between the spacer 33 and the substrates 31, 31′ is relatively large, and the bond strength and the stability between the spacer 33 and the substrates 31, 31′ are excellent.

Moreover, since the hollow part 122 of the spacer 33 communicates with the outside, a pressure difference does not occur between the inside (hollow part 122) of the optical resonator 114 and the outside. As a result, even if the volume in the hollow part 122 expands due to a temperature change or the like, the internal pressure does not increase, thereby preventing the bonding from being damaged by a stress applied to the joint portion between the spacer 33 and the substrates 31, 31′. As a result, the optical resonator 114 has excellent long-term reliability.

In the wavelength control module in the first example in this embodiment, the hollow part 122 of the optical resonator 114 communicates with the outside, and the optical resonator 114 is housed in a sealed housing. Therefore, even if the environmental temperature changes, the density in the hollow part 122 (medium 22) is constant, and the refractive index is kept constant. As a result, excellent temperature characteristic can be obtained.

Moreover, since the optical path from the collimator 12, passing through the optical resonator 114 and reaching the optical diode 15 is housed in a sealed housing, and the inside of the housing is replaced by dry nitrogen or dry air, the adhesive joining the spacer 33 and the substrates 31, 31′ is prevented from deteriorating due to the moisture.

According to the manufacturing method in the first example in this embodiment, the optical resonator, which has been heretofore assembled one by one, using minute parts, can be manufactured in a plurality of numbers at the same time, and hence productivity is good, enabling mass-production. Moreover, since the substrate base material 121 and the spacer base material 123 are relatively large members, the dimensional accuracy can be easily improved. By improving the dimensional accuracy of the substrate base material 121 and the spacer base material 123, the form accuracy in the optical resonator can be improved, and particularly, by increasing the accuracy of the cavity length d by thickness control of the spacer base material 123, the characteristics can be homogenized.

As a modified example of the first example in this embodiment, as shown in FIG. 5, by using a spacer base material 143 in which the thickness is gradually increasing or decreasing in one direction perpendicular to the thickness direction, an optical resonator having the configuration as shown in FIG. 6 can be manufactured. In FIG. 5 and FIG. 6, the same constituents as in FIG. 1 and FIG. 2 are denoted by the same reference symbols, and description thereof is omitted.

In the spacer base material 143 used in this modified example, one end face of the opposite end faces in the thickness direction inclines with respect to the other end face with a predetermined angle. The arrangement of the hollow parts 122 in the spacer base material 143 is such that when the spacer base material 143 is seen in plan view, the hollow parts 122 are formed in a line with a predetermined interval along a direction perpendicular to a direction in which the thickness gradually changes (in the A direction in the figure).

The optical resonator, whose cross section is shown in FIG. 6, can be obtained in a plurality of numbers at the same time, by using such a spacer base material 143 and manufacturing the optical resonator following the same procedures as in the above embodiment. In the optical resonator in this example, the one substrate 31 inclines with respect to the other substrate 31′, and hence the thickness of the hollow part 122 gradually changes, in a direction in which the thickness of the spacer 43 gradually changes (in the A direction in the figure).

In such an optical resonator, the inside of the hollow part 122 becomes a medium, and the thickness direction (lamination direction) becomes the traveling direction of light as shown by the broken line in the figure. However, in the direction in which the thickness of the spacer 43 gradually changes (in the A direction in the figure), if the position of incidence of light to the hollow part 122 is changed, the optical length in the hollow part (medium) 122 changes, and as a result, the transmission characteristic can be changed.

The transmission characteristic of the optical resonator in this example is determined by the variation in the thickness of the spacer 43. However, by manufacturing the optical resonator, using the spacer base material 143 as shown in FIG. 5, a plurality of optical resonators having excellent thickness accuracy can be manufactured collectively, and hence a difference in the characteristics between the products becomes very small.

A second example in this embodiment of the wavelength control module according to the present invention will be described below.

A different point of the wavelength control module in the first example in this embodiment from that of the first example in this embodiment is that the two substrates 31, 31′ and the spacer 33 in the optical resonator 114 in the first embodiment shown in FIG. 1, are joined with optical contact. Reflecting coatings (not shown) are formed on the whole surface of one face of the substrates 31, 31′, respectively, and the reflecting coatings come in direct contact with the spacer 33. An adhesive layer is not provided between the two substrates 31, 31′ and the spacer 33.

In this embodiment, the inner surfaces of the substrates 31, 31′ (opposite faces) and the opposite end faces of the spacer 33 in the thickness direction are smoothly polished, so as to have a profile irregularity as high as being capable of optical contact. The profile irregularity of these faces is preferably not larger than λ/4, and more preferably, not larger than λ/10.

In a second example of this embodiment, if bending occurs in the substrates 31, 31′, joining by optical contact may not be possible. Therefore, in order to prevent bending, it is desired to set the thickness of the substrates 31, 31′ to about 2 to 5 mm.

Manufacturing of the optical resonator in the second example in this embodiment is conducted by a method where the manufacturing method in the first example in this embodiment shown in FIG. 2 is changed such that before forming the reflecting coating 121a on one surface of the substrate base material 121, this one surface is polished to a specified profile irregularity, and the opposite end faces of the spacer base material 123 in the thickness direction is polished to a specified profile irregularity. Thereafter, the substrate base materials 121 and the spacer base material 123 are joined by optical contact to obtain a laminated body.

It is preferable to employ for example the Oscar method for the process for polishing the joint surface of the spacer base material 123 and the substrate base materials 121, so that profile irregularity as high as being capable of optical contact can be obtained.

Alternatively, the optical resonator in this embodiment can be manufactured by respectively cutting the spacer base material 123 and the substrate base materials 121 to a size of the spacer 33 and the substrates 31, 31′ constituting one optical resonator and joining these by optical contact.

In other words, the spacer base material 123 similar to that of the first example in this embodiment is prepared, and the opposite end faces thereof in the thickness direction are polished to the specified profile irregularity, and the spacer base material 123 is cut in the thickness direction between the adjacent hollow parts 122 so as to obtain the shape of the spacer 33 constituting the individual optical resonators.

On the other hand, the substrate base material 121 similar to that of the first example in this embodiment is prepared, and one surface thereof is polished to the specified profile irregularity, and then a reflecting coating 121a is formed on the polished surface. Thereafter, the substrate base material 121 is cut in the thickness direction so as to obtain the shape of the substrates 31, 31′ constituting the individual optical resonators.

Thereafter, two substrates 31, 31′ are made to face each other so that the reflecting coatings become inside, and the spacer 33 is therebetween, and these are integrated by optical contact, to thereby obtain the optical resonator in this embodiment.

According to the second example in this embodiment, an adhesive layer is not intervened between the substrates 31, 31′ and the spacer 33, but these are integrated by optical contact. As a result, dimensional variation of the optical resonator due to the temperature change further decreases, and an optical resonator having excellent temperature characteristic can be obtained. Moreover, since the spacer 33 is formed in a block and the joint area between the spacer 33 and the substrates 31,31′ is relatively large, the optical contact between the spacer 33 and the substrates 31, 31′ is stabilized, so that excellent bond strength can be obtained.

Furthermore, since the hollow part 122 in the spacer 33 communicates with the outside, then even if the volume in the hollow part 122 expands due to a temperature change or the like, the internal pressure does not increase, thereby preventing a stress from being applied to the joint portion between the spacer 33 and the substrates 31, 31′. As a result, the long-term reliability of the optical contact in the joint portion is improved.

Since an adhesive is not used in the joint portion between the spacer 33 and the substrates 31, 31′, there is no possibility that the adhesive deteriorates due to moisture or the like.

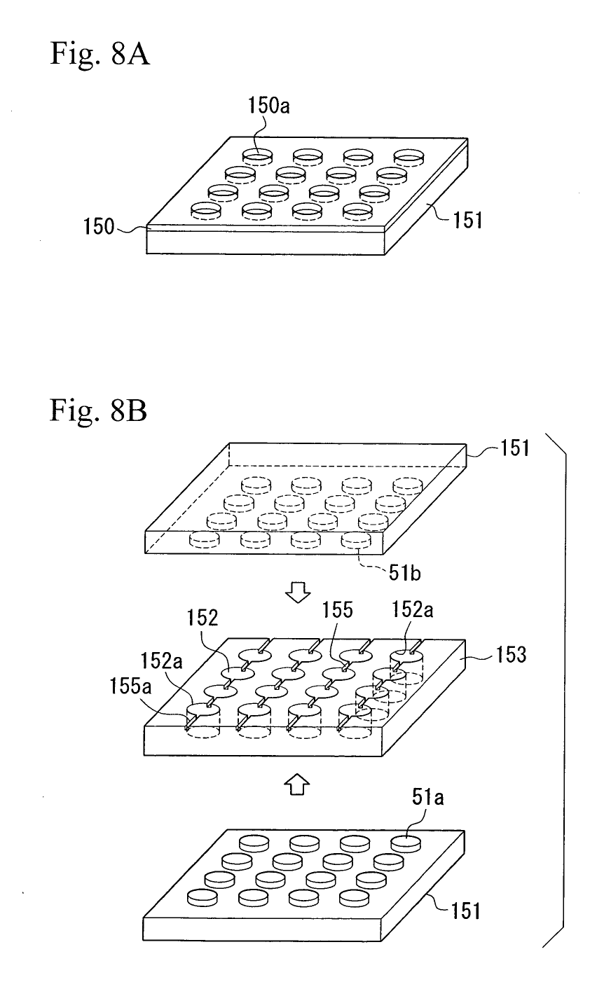

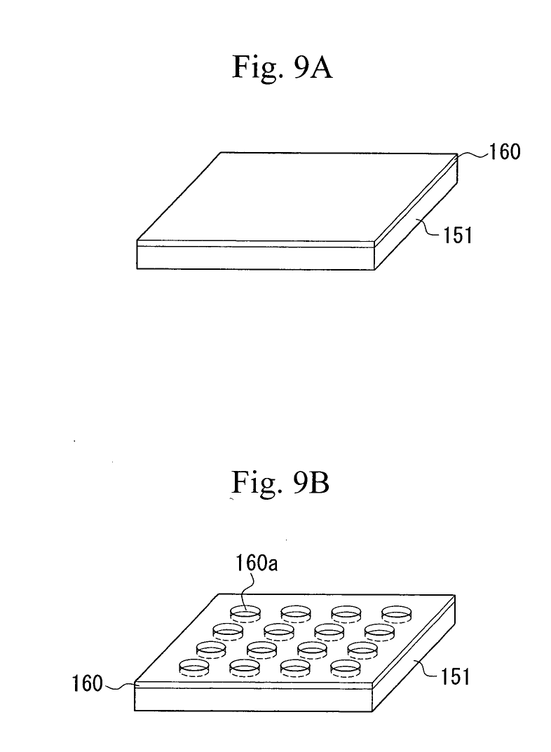

Also in this embodiment, as a modified example, as shown in FIG. 8, by using a spacer base material 143 in which the thickness is gradually increasing or decreasing in one direction perpendicular to the thickness direction, an optical resonator having the configuration as shown in FIG. 9 can be manufactured, in which optical contact is used for joining the substrates 31, 31′ and the spacer 43.

A third example in this embodiment of the wavelength control module of the present invention will be described below. A different point of the optical resonator in the third example in this embodiment from that of the first example in the first embodiment is that two substrates 51, 51′ and a spacer 53 constituting an optical resonator 54 are joined by optical contact, and that reflecting coatings 51a, 51b are provided only in areas on the opposite surfaces of the substrates 51 and 51′, and facing a hollow part 52. The reflecting coatings 51a and 51b do not come in contact with the spacer 53.

In this embodiment, the inside faces of the substrates 51, 51′ (opposite faces) and the opposite end faces of the spacer 53 in the thickness direction are polished to a specified profile irregularity, so as to obtain profile irregularity as high as being capable of optical contact. The profile irregularity of these faces is preferably not larger than λ/4, and more preferably, not larger than λ/10.

In the third example of this embodiment, if bending occurs in the substrates 51, 51′, joining by optical contact may not be possible. Therefore, in order to prevent bending, it is desired to set the thickness of the substrates 51, 51′ to about 2 to 5 mm.

In this embodiment, in a direction of a plane perpendicular to the thickness direction of the optical resonator 54, the size of the optical resonator 54 is set to 4 mm×5 mm, and the hollow part is formed in a circular shape with an inner diameter of 2 mm.

The optical resonator 54 in the third example in this embodiment can be manufactured, for example, by the following first to fourth manufacturing methods.

[First Manufacturing Method]

FIG. 8 shows the first manufacturing method for manufacturing the optical resonator 54 in this embodiment.

At first, a spacer base material 153 having a size of a plurality of spacers 53, each constituting one optical resonator, is prepared. This spacer base material 153 is a plate form with a constant thickness, and the front face and the rear face are parallel with each other. The shape of the spacer base material 153 in this embodiment may be the same as that of the first embodiment. That is, in the spacer base material 153, a plurality of hollow parts 152 penetrating the spacer base material 153 in the thickness direction is formed. Preferably the hollow parts 152 are formed so as to be arrayed in a matrix with a predetermined interval, when the spacer base material 153 is seen in plan view. Grooves 155 allowing the adjacent hollow parts 125 to communicate with each other are provided on the front face of the spacer base material 153, and the outermost hollow parts 152a communicate with the outside by the grooves 155a which open to the end face of the spacer base material 153.

The opposite end faces of the spacer base material 153 in the thickness direction are polished to specified profile irregularity by a polishing method such as the Oscar method. Polishing of the spacer base material 153 may be before or after forming the hollow parts 152, 152a and grooves 155, 155a.

On the other hand, two substrate base materials 151 having a planar shape of the same size as that of the spacer base material 153 are prepared, and one face thereof is polished to specified profile irregularity by the Oscar method or the like, respectively. As shown in FIG. 8A, a mask 150, in which openings 150a slightly smaller than the hollow parts 152 are formed in areas overlapping on the hollow parts 152 when the substrate base material 151 is laminated on the spacer base material 153, is laminated on the polished surface. For the mask 150, for example, a metal sheet having a thickness of about 100 μm, a polyimide sheet having a thickness of about 30 μm or the like is used.

In the third example in this embodiment, while the hollow part 152 in the spacer base material 153 is in a circular shape having an inner diameter of 2 mm, the opening portion 150a in the mask 150 is in a circular shape having an inner diameter of 1.8 mm, so that when the spacer base material 153 is laminated on the mask 150, the hollow part 152 and the opening portion 150a in the mask 150 are overlapped on each other in a concentric circular form.

Thereafter, a reflecting coating is evaporated on the whole surface of the mask 150 laminated on the substrate base material 151, to form a reflecting coating 51a (or 51b) on the opening portion 150a, and then the mask 150 is removed. As a result, as shown in FIG. 8B, there is obtained the substrate base material 151 in which the reflecting coatings 51a (or 51b) of a circular shape slightly smaller than the hollow parts 152 are formed in the areas overlapping on the hollow parts 152 when the substrate base material 151 is laminated on the spacer base material 153, on the polished surface of the substrate base material 151.

As shown in FIG. 8B, the two substrate base materials 151 are made to face each other, so that the reflecting coatings 51a, 51b become inside, and the spacer base material 153 is therebetween, and these are laminated to join the substrate base materials 151 and the spacer base material 153 by optical contact, to thereby obtain a laminated body.

Thereafter, the obtained laminated body is cut in the thickness direction between the adjacent hollow parts, and is separated for each hollow part 152, so that the optical resonator 54 in the third embodiment can be obtained.

In the third embodiment, since the hollow parts 152 are arrayed in a matrix with a predetermined interval in the spacer base material 153, by cutting the laminated body in a lattice form, a rectangular optical resonator 54 having one hollow part 152 at the center can be cut out in a plurality of numbers of the same size.

[Second Manufacturing Method]

In the first manufacturing method, after the spacer base material 153 and the substrate base materials 151 respectively having the reflecting coatings 51a, 51b formed thereon are respectively cut in a size of the spacer 53 and the substrates 51, 51′ constituting one optical resonator, these may be joined by optical contact. As a result, the optical resonator 54 in the third example in this embodiment can be manufactured.

That is to say, after polishing of the substrate base material 151 and formation of the circular reflecting coating 51a (51b) have been conducted in the same manner as the first manufacturing method, the substrate base material is cut in the thickness direction so as to obtain the shape of the substrates 51, 51′, constituting the individual optical resonator 54.

On the other hand, after having polished the spacer base material 153, the spacer base material 153 is cut in the thickness direction between the adjacent hollow parts 122 so as to obtain the shape of the spacer 53 constituting the individual optical resonators 54.

Thereafter, the two substrates 51, 51′ are made to face each other so that the reflecting coatings 51a, 51b become inside, and the spacer 53 is therebetween, and these are integrated by optical contact, to thereby obtain the optical resonator 54.

[Third Manufacturing Method]

FIG. 9 is a diagram for explaining the third manufacturing method for manufacturing the optical resonator 54 in this embodiment. At first, in the same manner as the first manufacturing method, a spacer base material 153 of a size for a plurality of spacers 53, each constituting one optical resonator 54 as shown in FIG. 8B is prepared, and polishing of the opposite end faces and formation of hollow parts 152, 152a and grooves 155 and 155a are performed. Polishing of the spacer base material 153 may be before or after forming the hollow parts 152, 152a and grooves 155, 155a.

On the other hand, two substrate base materials 151 having a planar shape of the same size as that of the spacer base material 153 are prepared, and one face thereof is polished to specified profile irregularity by the Oscar method or the like, respectively. As shown in FIG. 9A, a photomask 160 is formed over the whole face of the polished surface. As shown in FIG. 9B, exposure and etching are conducted so that openings 160a slightly smaller than the hollow parts 152 are formed in areas overlapping on the hollow parts 152 when the substrate base material 151 is laminated on the spacer base material 153.

Thereafter, a reflecting coating is evaporated on the whole surface of the photomask 160 laminated on the substrate base material 151, to form a reflecting coating 51a (or 51b) on the opening portion 160a, as shown in FIG. 9B, and then the photomask 160 is removed. As a result, as shown in FIG. 9B, there is obtained the substrate base material 151 in which the reflecting coatings 51a (or 51b) of a circular shape slightly smaller than the hollow parts 152 are formed in the areas overlapping on the hollow parts 152 when the substrate base material 151 is laminated on the spacer base material 153, on the polished surface of the substrate base material 151.

As described above, if the mask covering the portion where the reflecting coatings 51a (51b) are not formed on the surface of the substrate base material 151 is formed of the photoresist layer 160, it is easy to make the mask film thin, and as the mask becomes thinner, the form accuracy and the characteristics of the reflecting coating 51a (51b) formed thereon by vapor deposition are improved.

Thereafter, as shown in FIG. 8B, the two substrate base materials 151 are made to face each other, so that the reflecting coatings 51a, 51b become inside, and the spacer base material 153 is therebetween and these are laminated to join the substrate base materials 151 and the spacer base material 153 by optical contact, to thereby obtain a laminated body.

Lastly, the obtained laminated body is cut in the thickness direction between the adjacent hollow parts, and is separated for each hollow part 152, so that the optical resonator 54 in the this embodiment can be obtained.

[Fourth Manufacturing Method]

In the third manufacturing method, after the spacer base material 153 and the substrate base materials 151 respectively having the reflecting coatings 51a, 51b formed thereon are respectively cut in a size of the spacer 53 and the substrates 51, 51′ constituting one optical resonator, these may be joined by optical contact. As a result, the optical resonator 54 in this embodiment can be manufactured.

That is to say, after polishing of the substrate base material 151 and formation of the circular reflecting coating 51a (51b) have been conducted in the same manner as the third manufacturing method, the substrate base material is cut in the thickness direction so as to obtain the shape of the substrates 51, 51′ constituting the individual optical resonator 54.

On the other hand, after having polished the spacer base material 153, the spacer base material 153 is cut in the thickness direction between the adjacent hollow parts 122, so as to obtain the shape of the spacer 53 constituting the individual optical resonators 54.

Thereafter, the two substrates 51, 51′ are made to face each other so that the reflecting coatings 51a, 51b become inside, and the spacer 53 is therebetween, and these are integrated by optical contact, to thereby obtain the optical resonator 54.

According to this embodiment, the same working effects as those of the second embodiment can be obtained, and particularly, since the reflecting coating is not intervened between the substrates 51, 51′ and the spacer 53, and these are integrated by optical contact, the bond strength is improved.

Also in this embodiment, as a modified example, as shown in FIG. 5, by using a spacer base material 143 in which the thickness is gradually increasing or decreasing in one direction perpendicular to the thickness direction, an optical resonator having the configuration as shown in FIG. 6 can be manufactured, in which optical contact is used for joining the substrates 51, 51′ and the spacer 43.

Specific examples in the embodiment and the test results are shown below.

### EXAMPLE 1

The optical resonator 114 was manufactured by the method shown in FIG. 2. At first, two substrate base materials 121 consisting of glass are prepared, and a reflecting coating 121a comprising SiO₂ and TiO₂ or Ta₂O₂ was formed on the whole surface of one surface thereof, respectively, by using an ion assist vapor deposition method. The size of the substrate base material 121 was such that the length was from 50 to 100 mm, the width was from 50 to 100 mm, the thickness was from 2 to 5 mm, and the thickness of the reflecting coating 121a was from 1 to 7 μm. The reflectance on the reflecting surface of the substrate base material 121 was 90%.

Separately, a spacer base material 123 consisting of Zerodur (trademark, coefficient of linear expansion=0.02×10⁻⁶/K) was prepared. The size of the spacer base material 123 was such that the length was from 50 to 100 mm, the width was from 50 to 100 mm, the thickness was from 1.5 to 6 mm, and cylindrical hollow parts 122 having an inner diameter of 1.5 mm were formed by boring by an ultrasonic machining method. The hollow parts 122 were provided so as to line up in a matrix, when the spacer base material 123 was seen in plan view, the interval between the centers of the adjacent hollow parts 122 was 3 mm respectively, and the distance between the center of the outermost hollow part 122a and the end face of the spacer base material 123 was 1.5 mm. On one surface of the spacer base material 123, grooves 125 were formed, using a dicer, along a line passing through the center of each hollow part 122 and parallel to the side of the spacer base material 123. The width of the groove 125 was 0.5 mm, the depth was 0.5 mm, and the groove was formed from one end to the other end in the horizontal direction of the spacer base material 123.

On the opposite faces of the spacer base material 123, epoxy resin was applied as an adhesive in a thickness of 1 μm, and the substrate base material 121 was respectively overlapped thereon with the reflecting coating 121a being inside, and fixed by bonding.

A laminated body obtained in this manner was cut in a lattice form with 3 mm intervals in the transverse direction and with 3 mm intervals in the longitudinal direction, using a dicer, to thereby obtain the optical resonators 114.

In the wavelength control module 11 shown in FIG. 25, the optical resonator 114 manufactured above was used instead of the optical resonator 14, and the optical path from the collimator 12 (input device), passing through the optical resonator 14 and reaching the first and second optical diodes 15 and 17 (detection device) was housed in a sealable housing consisting of covar, to thereby prepare a wavelength control module. Since a temperature sensor 18 was not necessary, it was not provided.

A wavelength control system for an LD light source 1 as shown in FIG. 1 was constructed, using this wavelength control module.

### TEST EXAMPLE 1

The wavelength-transmittance characteristic of the optical resonator 114 was measured, using the wavelength control module prepared in Example 1, to obtain the central wavelength at which the transmittance showed a peak. Variation in the central wavelength was studied, when the environmental temperature was increased from 0° C. by 10° C. up to 70° C., and then dropped from 70° C. to 0° C. by 11° C. The angle of incidence θ with respect to the substrate was made constant.

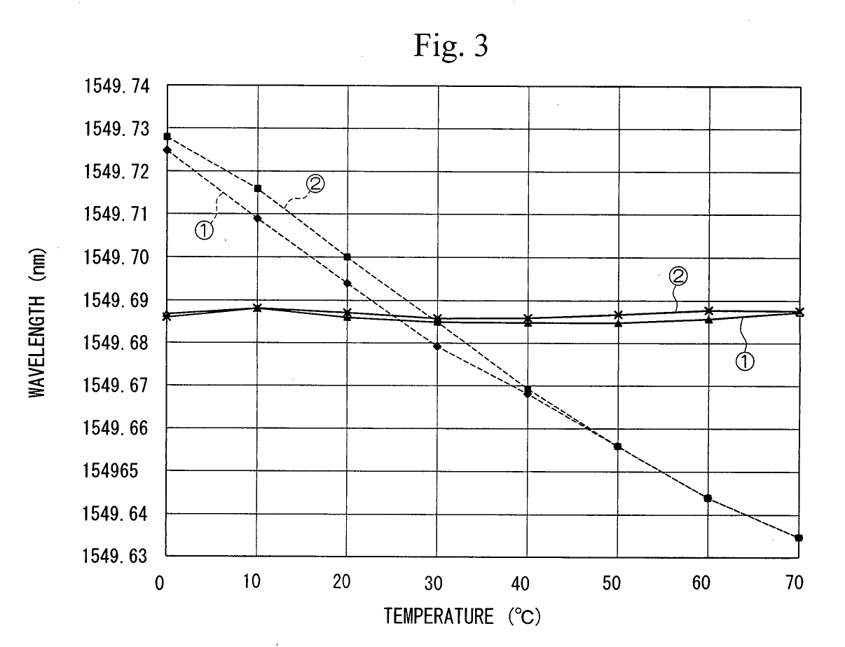

As a result of measurement of 20 wavelength control modules, it was recognized that as shown by the solid line in FIG. 3, the variation margin of the central wavelength was suppressed within a range of from 5 to 30 pm with respect to the temperature change of from 0 to 70° C., and hence the wavelength control modules had excellent characteristic stability with respect to temperature change.

In the graph in FIG. 3, the X axis shows the environmental temperature, and the Y axis shows the central wavelength. The graph (1) shows the measurement result at the time of temperature rise, and the graph (2) shows the measurement result at the time of temperature drop (the same applies hereunder).

### TEST EXAMPLE 2

A wavelength control module was prepared in the same manner as in Example 1, except that the housing which houses the optical path from the collimator 12 (input device), passing through the optical resonator 14 and reaching the first and second optical diodes 15 and 17 (detection device) was an open system, without sealing the housing.

The wavelength-transmittance characteristic of the optical resonator was measured, in the same manner as in Test Example 1, using this wavelength control module, and variation of the central wavelength accompanying a change in the environmental temperature was studied. The result is shown by the broken line in FIG. 3.

As shown in this figure, when the housing which houses the optical resonator was the open system, the variation margin of the central wavelength with respect to a temperature change of from 0 to 70° C. increased up to about 100 pm.

### TEST EXAMPLE 3

The wavelength control module was prepared in the same manner as in Example 1, except that ULE (trademark, coefficient of linear expansion=0.02×10⁻⁶/K) was used as the material forming the spacer.

The wavelength-transmittance characteristic of the optical resonator was measured, in the same manner as in Test Example 1, using this wavelength control module, and variation of the central wavelength accompanying a change in the environmental temperature was studied.

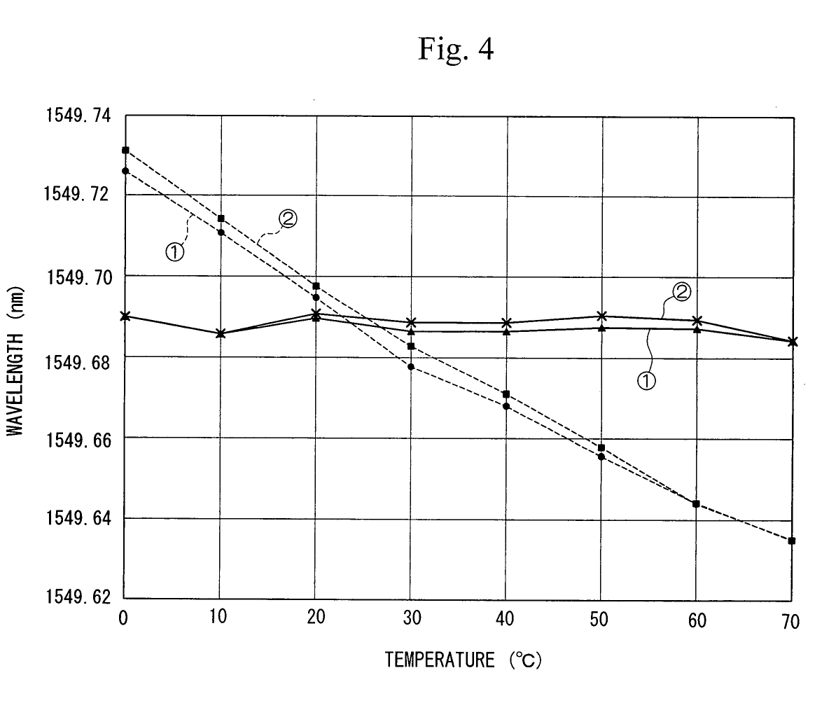

As a result of measurement of 20 wavelength control modules, it was recognized that as shown by the solid line in FIG. 4, the variation margin of the central wavelength was suppressed within a range of from 5 to 30 pm with respect to the temperature change of from 0 to 70° C., and the wavelength control modules had excellent characteristic stability with respect to temperature change.

### TEST EXAMPLE 4

A wavelength control module was prepared in the same manner as in Example 1, except that ULE (trademark, coefficient of linear expansion=0.02×10⁻⁶/K) was used as the material forming the spacer, and the housing which houses the optical path from the collimator 12 (input device), passing through the optical resonator 14 and reaching the first and second optical diodes 15 and 17 (detection device) was an open system, without sealing the housing.

The wavelength-transmittance characteristic of the optical resonator was measured, in the same manner as in Test Example 1, using this wavelength control module, and variation of the central wavelength accompanying a change in the environmental temperature was studied. The result is shown by the broken line in FIG. 4.

As shown by the broken line in FIG. 4, when the housing which houses the optical resonator was the open system, the variation margin of the central wavelength with respect to a temperature change of from 0 to 70° C. increased up to about 100 pm.

### EXAMPLE 2

The optical resonator 54 was manufactured by the method shown in FIG. 8.

That is to say, at first, a spacer base material 153 consisting of Zerodur (trademark, coefficient of linear expansion=0.02×10⁻⁶/K) was prepared. The size of the spacer base material 153 was such that the length was from 50 to 100 mm, the width was from 50 to 100 mm, the thickness was from 1.5 to 6 mm, and cylindrical hollow parts 152, 152a having an inner diameter of 2.0 mm were formed by boring. Moreover, the opposite end faces of the spacer base material 153 in the thickness direction were polished by the Oscar method so as to obtain profile irregularity of λ/10.

On the other hand, two substrate base materials 151 consisting of glass were prepared, and one surface thereof was respectively polished by the Oscar method so as to obtain profile irregularity of λ/10. The size of the substrate base material 151 was such that the length was from 50 to 100 mm, the width was from 50 to 100 mm, and the thickness was from 2 to 5 mm. Then, as shown in FIG. 8A, a mask 150 was laminated on the polished surface, and a reflecting coating was evaporated on the whole surface. The mask 150 was then removed, to thereby form a reflecting coating 51a (51b), the thickness of the reflecting coating 51a (51b) was from 1 to 7 μm, and the reflectance was 90%.

As shown in FIG. 8B, the two substrate base materials 151 were made to face each other, so that the reflecting coatings 51a, 51b became inside, and the spacer base material 153 was therebetween and laminated to join the substrate base materials 151 and the spacer base material 153 by optical contact, to thereby obtain a laminated body.

Thereafter, the obtained laminated body was cut in a lattice form so as to obtain a size of 4 mm×5 mm, using a dicer, and was separated for each hollow part 152, so that the optical resonator 54 was obtained.

The wavelength control module was formed in the same manner as in Example 1, using the obtained optical resonator 54, and a wavelength control system using this module was constructed.

### TEST EXAMPLE 5

The wavelength-transmittance characteristic of the optical resonator was measured, in the same manner as in Test Example 1, using the wavelength control module prepared in Example 2, and variation of the central wavelength accompanying a change in the environmental temperature was studied.

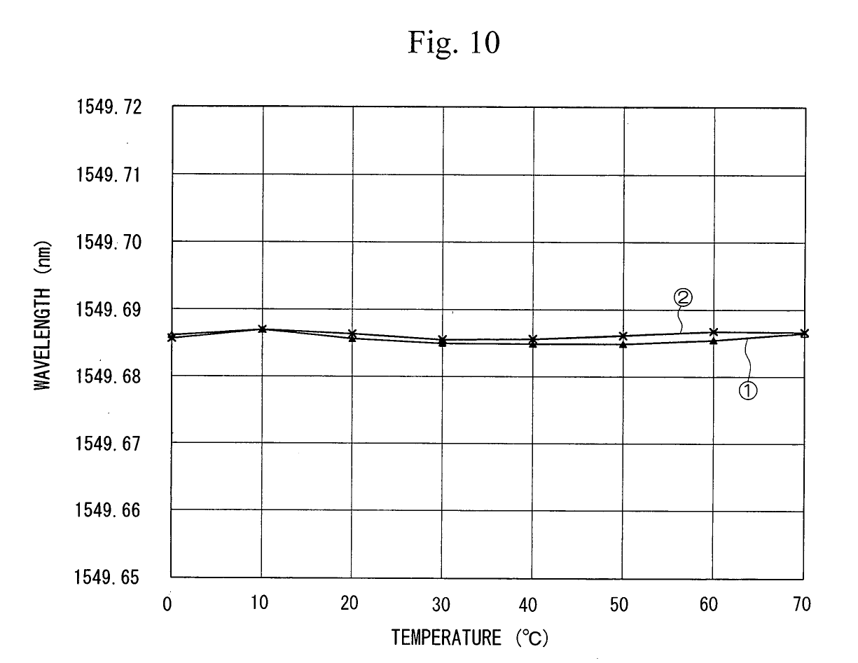

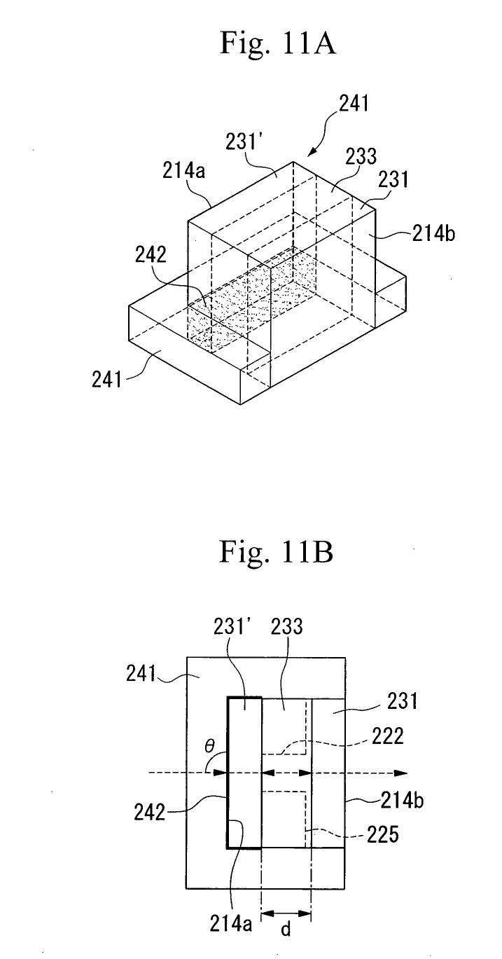

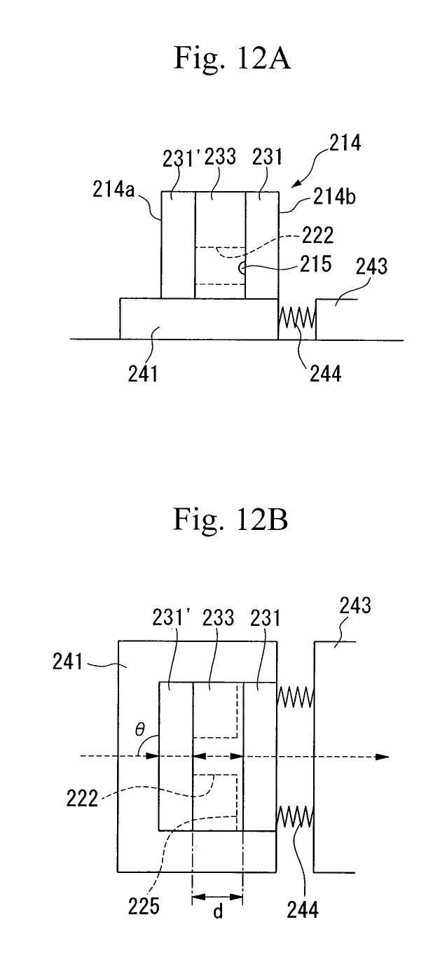

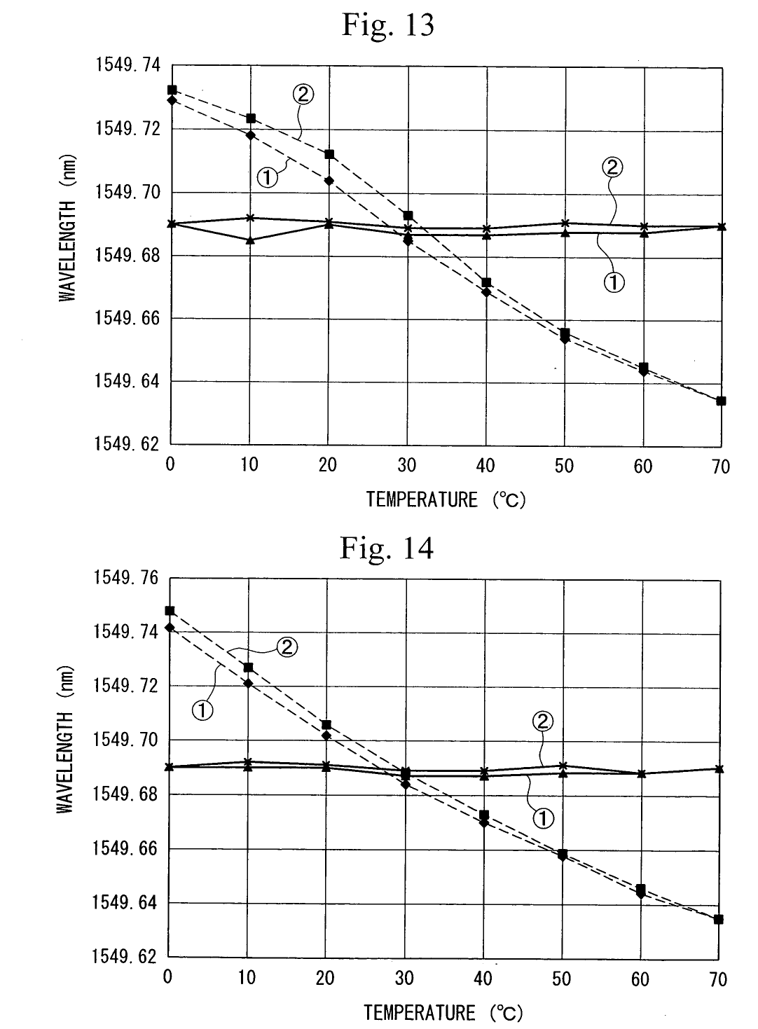

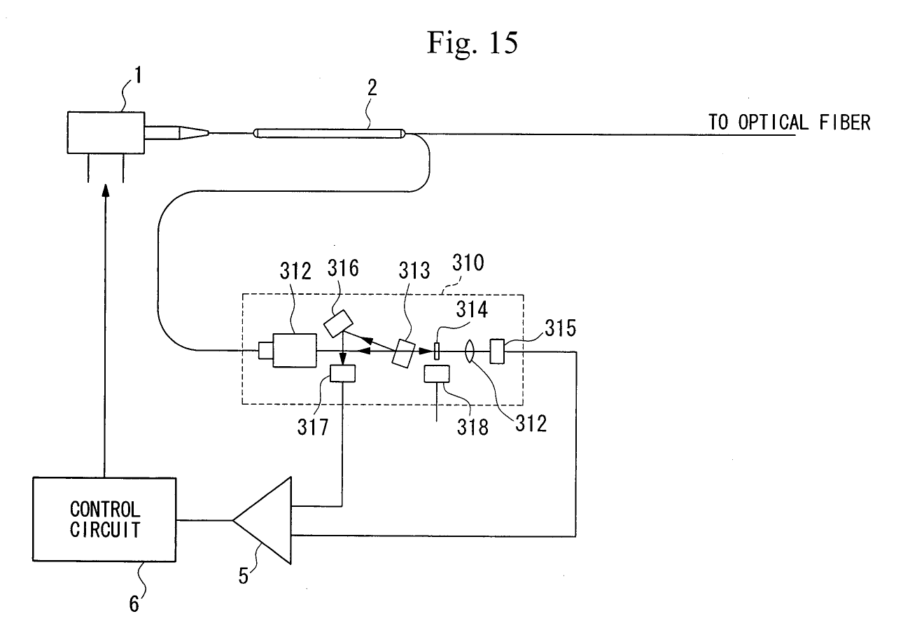

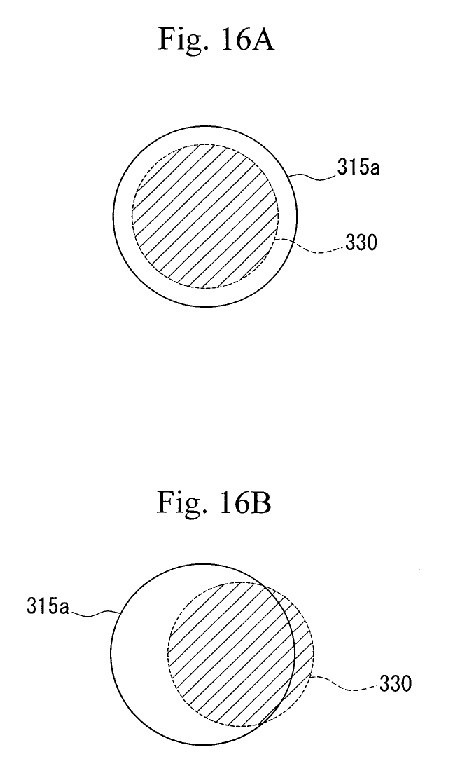

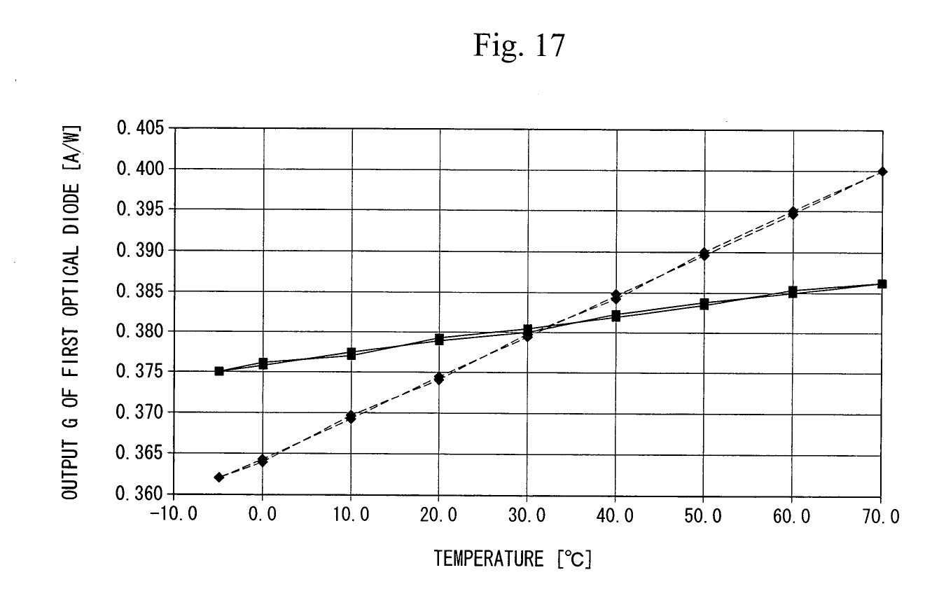

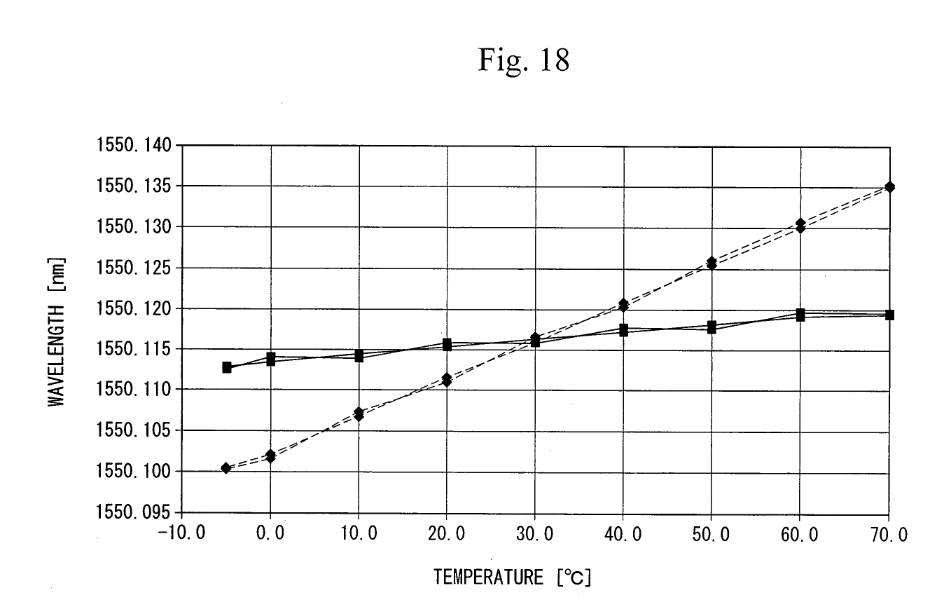

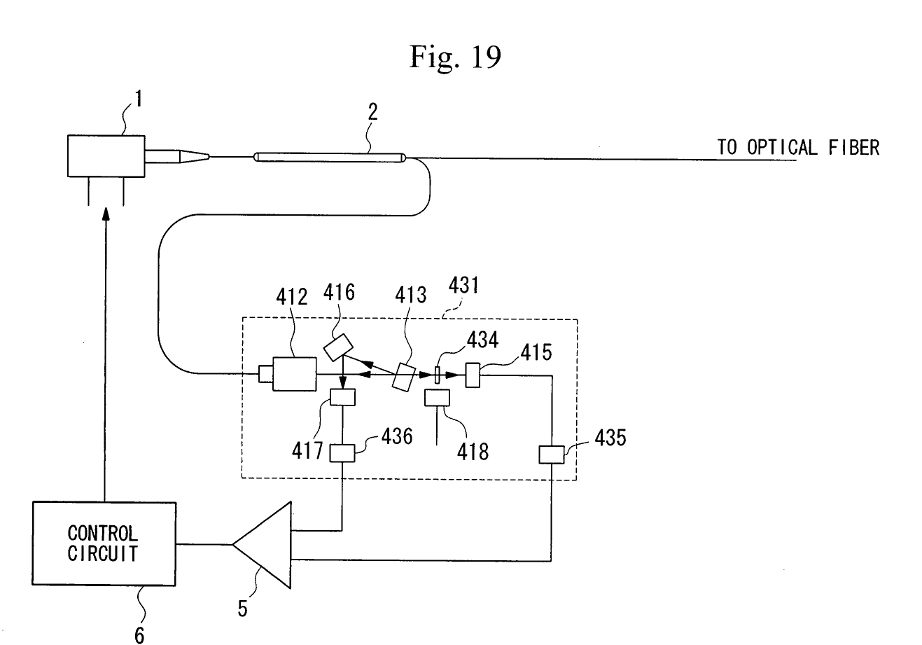

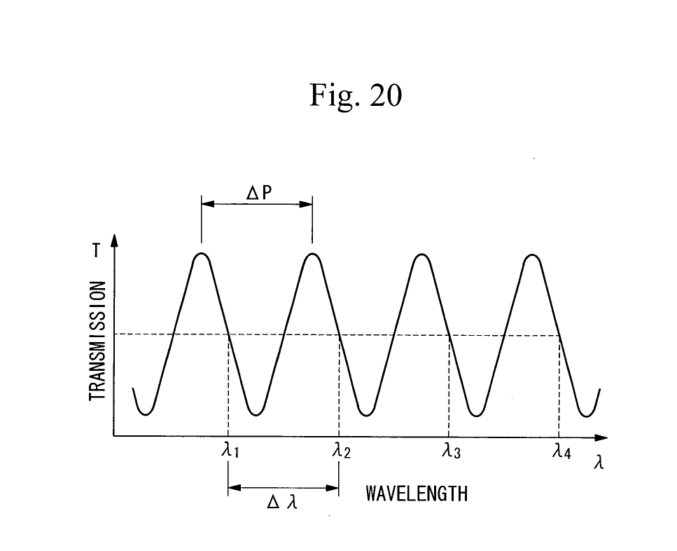

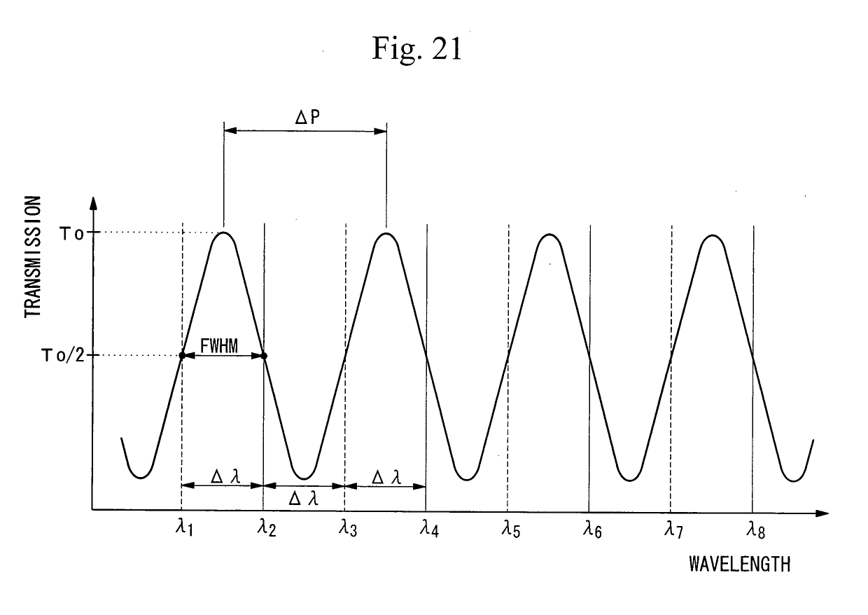

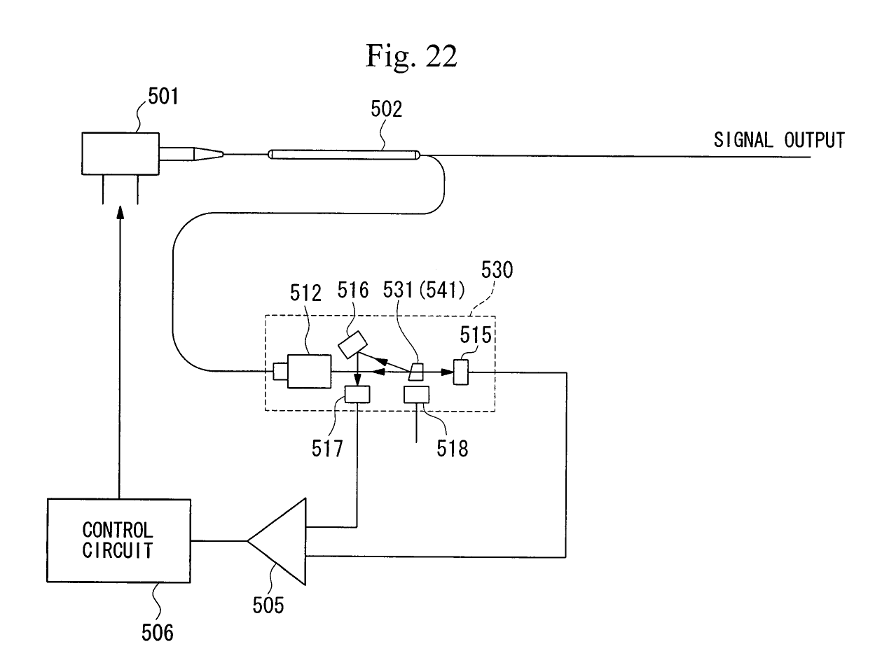

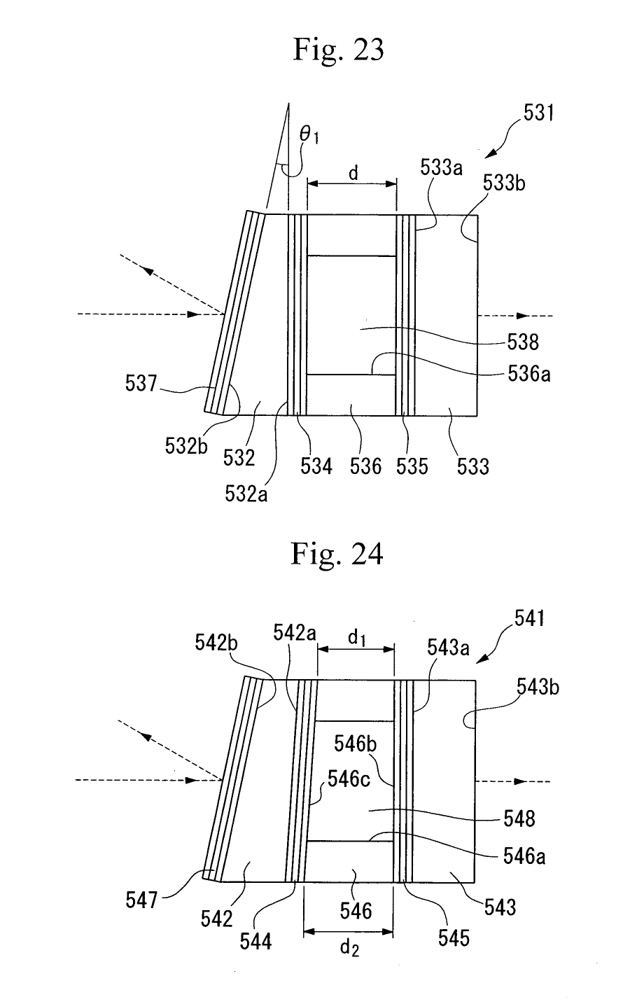

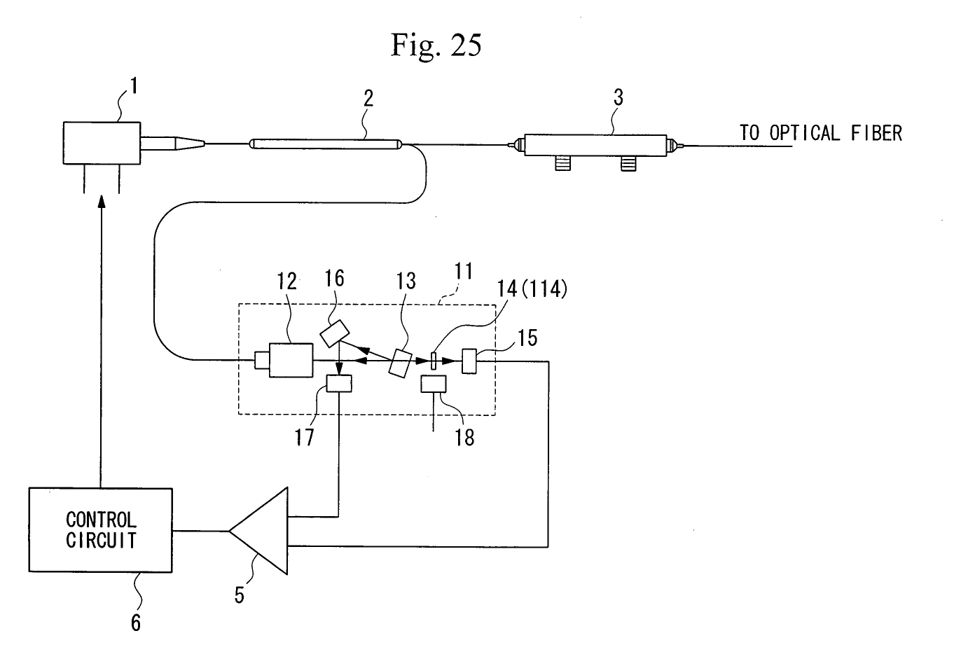

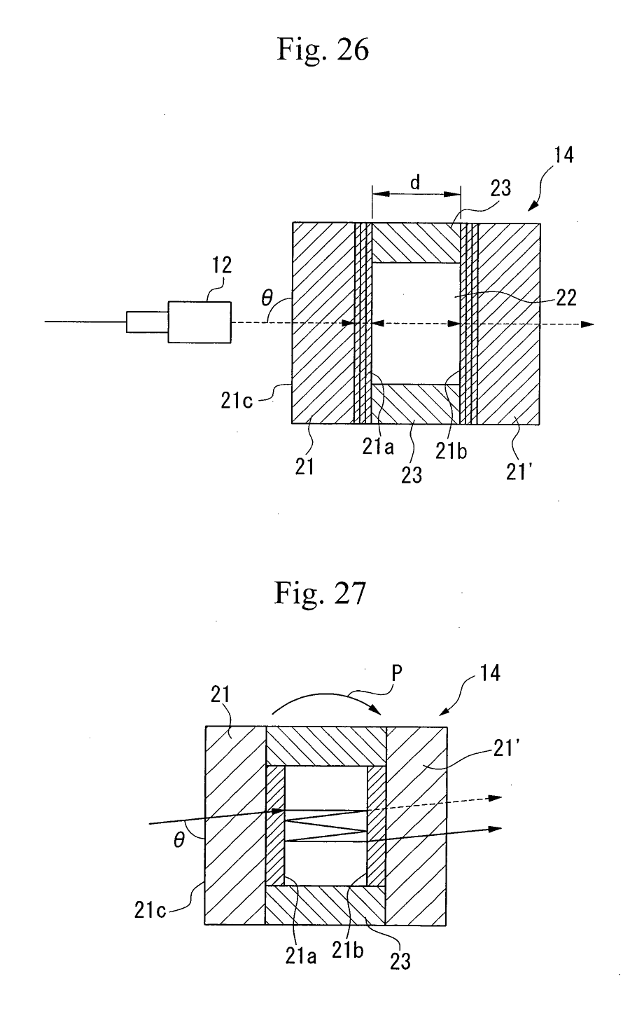

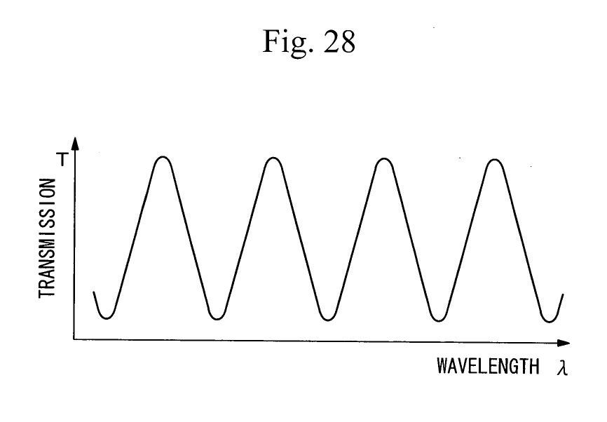

As a result of measurement of 20 wavelength control modules, as shown in FIG. 10, the variation margin of the central wavelength was suppressed within a range of from 5 to 10 pm with respect to the temperature change of from 0 to 70° C., and the characteristic stability with respect to temperature change was improved even more than in Example 1, by using the optical contact.

As described above, according to the first aspect of the present invention, the temperature characteristic of the optical resonator can be improved, and the temperature characteristic of the wavelength control module can be also improved. For example, in the wavelength control module, it is possible to suppress the variation of the central wavelength at which the transmittance shows a peak due to a temperature change of from 0 to 70° C., to 30 pm or less, and preferably to 10 pm or less. Hence, by using the wavelength control module of the present invention in the wavelength control system for the LD light source, the emission wavelength of the LD light source can be controlled highly accurately, without providing equipment or a circuit for temperature compensation in the wavelength control module. As a result, the variation margin of the emission wavelength of the LD light source can be suppressed, and hence a requirement for coping with an increase in density of the wavelength interval up to about 25 to 50 GHz in the WDM mode can be satisfied. Moreover, since a temperature sensor is not necessary in the wavelength control module, small size and low cost of the wavelength control module can be realized.

By this aspect, the long-term reliability of the optical resonator and the wavelength control module can be improved, and for example, it is possible to correspond to a requirement of 25 years guarantee.

According to the manufacturing method for the optical resonator in this aspect, an optical resonator having high accuracy can be manufactured with good productivity, and mass-production is also possible.

The second aspect of the present invention, whose object is to highly stabilize the transmission characteristic of the optical resonator, will be described below in detail.

FIG. 11 shows a main part of the optical resonator according to a first embodiment in the second aspect, wherein FIG. 11A is a perspective view, and FIG. 11B is a plan view as seen from above.

An optical resonator 214 in the first embodiment is constructed such that two rectangular substrates 231, 231′ having a reflecting coating (not shown) are respectively laminated on the opposite end faces of a rectangular block-shaped spacer 233 in a block form in the thickness direction, so that the reflecting coating becomes inside. The reflectance on the reflecting surface of the substrates 231, 231′ is generally set within a range of from 40 to 90%. In this embodiment, it is set to 90%.

In FIG. 11A, though not shown, the spacer 233 is provided with a hollow part 222 penetrating in the thickness direction, and the hollow part 222 communicates with the outside by grooves 225.

In such an optical resonator 214, the opposite end faces 214a, 214b perpendicular to the thickness direction (lamination direction) become the plane of incidence and an outgoing plane of the light, respectively, the inside of the hollow part 222 becomes the medium, and the thickness direction (lamination direction) becomes the traveling direction of light as shown by the broken line in FIG. 11B.

The hollow part 222 communicates with the outside of the optical resonator 214 by the groove 225, and hence the hollow part (air layer) 222 is open. Therefore, even if the temperature changes, a pressure difference does not occur in the inside and the outside of the hollow part (air layer) 222, and hence there is no possibility that bonding in the joint portion of the substrates 231, 231′ and the spacer 233 is damaged.

Though not shown, the optical resonator 214 is housed in a sealed housing, together with an input device which inputs parallel light and a device which detects a change in the intensity of the transmitted light.

The feature of the optical resonator in the second aspect is that a fixing member 241 is provided on the inner face of the housing, with the planar shape being substantially in a letter C shape, and the optical resonator 214 is arranged in the fixing member 241, so that the bottom face thereof which is parallel with the traveling direction of light comes in contact with the inner face of the housing. The inner face of the fixing member 241 is formed in substantially the same shape as the planar shape when the optical resonator 214 is seen from the above, and two sides of the four sides of the optical resonator 214, parallel with the traveling direction of light, and one side perpendicular to the traveling direction of light come in contact with the inner surface of the fixing member 241. The height of the fixing member 241 is set to a height that does not block incident and outgoing radiation of light in the optical resonator 214.

In this example, an adhesive is used as the means for fixing the optical resonator with respect to the housing and the fixing member 241. Reference symbol 242 in FIG. 11 denotes the adhesive, which is shown by diagonal lines in FIG. 1A. In the second embodiment, only one substrate of the two substrates 231, 231′ constituting the optical resonator 214 is integrated with the housing and the fixing member 241 by the adhesive 242. In other words, only the bottom face and the three sides of the substrate 231′ having the plane of incidence 214a are fixed by bonding on the inner side of the housing and the inner surface of the fixing member 241 by the adhesive 242.

For the adhesive 242, for example, an epoxy resin is preferably used.

Also in this second embodiment of the second aspect, the spacer is formed from a material having a coefficient of linear expansion of almost zero. The allowable range of the coefficient of linear expansion may be within a range of from about −0.02×10⁻⁶/K to +0.02×⁻⁶/K, though it depends on the stability level of the temperature characteristic to be obtained. A specific example of the material constituting the spacer having a coefficient of linear expansion of almost zero includes Zerodur (trademark), ULE (trademark) and the like.

According to the second embodiment in the second aspect, the bottom face of the optical resonator 214 constituting the wavelength control module is fixed on the inner side of the housing, and the fixing member substantially in a letter C shape which comes in contact with three sides of the optical resonator 214 is provided on the inner side of the housing. As a result, movement of the optical resonator 214 in a rotational direction centering on an axis parallel to the plane of incidence 214a is suppressed.

Moreover, since only one substrate 231′ of the constituents of the optical resonator 214 is fixed by bonding on the inner side of the housing and the fixing member 41, variations in the fixed position of the optical resonator 214 due to the thermal expansion of the housing and the fixing member 241 can be prevented.

As a result, a variation in the angle of incidence θ with respect to the plane of incidence 214a of the optical resonator 214 can be prevented, and as a result the stability of the transmission characteristic of the optical resonator 214 can be improved.

Moreover, by constructing the spacer 233 from a material having a coefficient of linear expansion of almost zero, a variation in the gap length d accompanying temperature change can be prevented. Furthermore, by making the housing a sealed system, a variation in the refractive index n accompanying temperature change can be suppressed. As a result, the temperature characteristic of the optical resonator is improved and the transmission characteristic of the optical resonator can be further stabilized.

In this embodiment, one substrate 231′ in the optical resonator 214 is fixed by bonding to both of the housing and the fixing member 241. However, only one substrate 231′ in the optical resonator 214 may be fixed by bonding to the housing, or only to the fixing member 241. Particularly, it is preferable to fix the one substrate 231′ to both of the housing and the fixing member 241, in order to obtain high reliability.

FIG. 12A and FIG. 12B show the optical resonator in a second embodiment in the second aspect, wherein FIG. 12A is a side view and FIG. 12B is a plan view as seen from the above. In FIG. 12, the same constituents as those of the optical resonator in FIG. 11 are denoted by the same reference symbols, and description thereof is omitted.

A different point of the optical resonator in the second embodiment from that of the first embodiment is that an opposing member 243 having a face opposite to the outgoing plane 214b of the optical resonator 214 is provided, with the optical resonator 214 disposed in the fixing member 241, and a resilient member 244 is disposed between the opposing member 243 and the outgoing plane 214b of the optical resonator 214.

The resilient member 244 is for urging the optical resonator 214 in a direction of pushing toward the fixing member 241, and for example, a plate spring, a spring or the like is preferably used. The shape of the opposing member 243 and the arrangement of the resilient member 244 are limited so as not to block the incident and outgoing radiation of light in the optical resonator 214.

In the second embodiment, only the bottom face of the substrate 231′ having the plane of incidence 214a, of the two substrates 231, 231′ constituting the optical resonator 214, is fixed by bonding on the inner side of the housing by an adhesive (not shown).

According to the second embodiment, not only the same working effects as those in the first embodiment are obtained, but also the reliability in the geometrical arrangement of each element in the optical resonator can be improved, by fixing the optical resonator 214 to the fixing member 241 and using the resilient member 244 as a means for suppressing the movement thereof.

The manufacturing method for the optical resonator 214 in the first and second embodiments is the same as the manufacturing method shown in FIG. 2.

According to this manufacturing method, the optical resonator, which has been heretofore assembled one by one, using minute parts, can be manufactured in a plurality of numbers at the same time. As a result, the productivity is good, and mass-production becomes possible. Moreover, since the substrate base material 121 and the spacer base material 123 are relatively large members, the dimensional accuracy can be easily improved. By improving the dimensional accuracy of the substrate base material 121 and the spacer base material 123, the form accuracy in the optical resonator can be improved, and particularly, by increasing the accuracy of the cavity length d by thickness control of the spacer base material 123, the characteristics can be homogenized.

In the above two embodiments, the member substantially in a letter C shape, protruding on the inner side of the housing is provided as the fixing member for preventing the constituents of the optical resonator 214 from moving, but the fixing member is not limited thereto, and can be appropriately changed, so long as it can prevent the movement of the optical resonator 214 in the rotational direction about the axis parallel to the plane of incidence 114a. For example, a concave portion capable of housing the bottom of the optical resonator 114 without any gap may be provided in the inner side of the housing.

In the above two embodiments, in the optical resonator 214, the plane of incidence 214a and the outgoing plane 214b shown in FIG. 1A may be the other way around.

Moreover, a resilient member for urging the bottom face of the optical resonator 214 in a direction pushing toward the inner face of the housing may be used, without using the adhesive for fixing the optical resonator 214 in the housing.

Specific examples of the second aspect of the present invention and the test results are shown below.

### EXAMPLE 3

An optical resonator in FIG. 2 was manufactured by the method shown in FIG. 2, specifically as shown in Example 1.

In the wavelength control module 11 shown in FIG. 25, the optical resonator 114 in the first aspect was used instead of the optical resonator 14, and the optical path from the collimator 12 (input device), passing through the optical resonator 14 and reaching the first and second optical diodes 15 and 17 (detection device) was housed in a sealable housing having the fixing member 41 as shown in FIG. 1, to prepare a wavelength control module. An epoxy resin was used for fixing the optical resonator 214, and as shown by the dotted area in FIG. 11A, only the bottom face and the three sides of the substrate 241 having the plane of incidence 214a are fixed by bonding on the inner side of the housing and the inner surface of the fixing member 241 by an adhesive 242.

By using the wavelength control module having such an optical resonator incorporated therein, a wavelength control system for the LD light source 1 as shown in FIG. 25 was constructed.

### TEXT EXAMPLE 6

For the optical resonator 214 prepared by Example 3, the wavelength-transmittance characteristic of the optical resonator 214 was measured by using the wavelength control module shown in FIG. 25, to obtain the central wavelength at which the transmittance showed a peak. Variation in the central wavelength was studied, when the environmental temperature was increased from 0° C. by 10° C. up to 70° C., and then dropped from 70° C. to 0° C. by 10° C.

The result is shown by the solid line in FIG. 13. In the graph in FIG. 13, the X axis shows the environmental temperature, and the Y axis shows the central wavelength. In FIG. 13, (1) shows the measurement result at the time of temperature rise, and (2) shows the measurement result at the time of temperature drop.

As shown in this figure, it was recognized that the variation margin of the central wavelength was suppressed to about 5 pm with respect to the temperature change of from 0 to 70° C., and the wavelength control module had excellent characteristic stability with respect to temperature change.

### TEST EXAMPLE 7

The wavelength control module was prepared in the same manner as in Example 3, except that the housing was an open system, without sealing the housing.

The wavelength-transmittance characteristic of the optical resonator was measured, in the same manner as in Test Example 6, using this wavelength control module, and variation of the central wavelength accompanying a change in the environmental temperature was studied. The result is shown by the broken line in FIG. 13.

As shown in this figure, when the housing which houses the optical resonator was the open system, the variation margin of the central wavelength with respect to a temperature change of from 0 to 70° C. increased up to about 100 pm.

### TEST EXAMPLE 8

The wavelength control module was prepared in the same manner as in Example 3, except that ULE (trademark, coefficient of linear expansion=0.02×10⁻⁶/K) was used as the material forming the spacer.

The wavelength-transmittance characteristic of the optical resonator was measured, in the same manner as in Test Example 6, using this wavelength control module, and variation of the central wavelength accompanying a change in the environmental temperature was studied. The result is shown by the solid line in FIG. 18.

As shown in this figure, results as good as those of Test Example 6 were obtained, such that even if the material of the spacer was changed, the variation margin of the central wavelength with respect to a temperature change of from 0 to 70° C. was about 5 pm.

### TEST EXAMPLE 9

A wavelength control module was prepared in the same manner as in Example 3, except that ULE (trademark, coefficient of linear expansion=0.02×10⁻⁶/K) was used as a material forming the spacer, and the housing was an open system, without sealing the housing.

The wavelength-transmittance characteristic of the optical resonator was measured, in the same manner as in Test Example 1, using this wavelength control module, and variation of the central wavelength accompanying a change in the environmental temperature was studied. The result is shown by the broken line in FIG. 14.

As shown in this figure, when the housing which houses the optical resonator was the open system, the variation margin of the central wavelength with respect to a temperature change of from 0 to 70° C. increased up to about 120 pm.

As described above, according to the second aspect of the present invention, by fixing the optical resonator constituting the wavelength control module by a fixing member, the transmission characteristic thereof can be stabilized. For example, the variation of the central wavelength, at which the transmittance shows a peak, due to a temperature change of from 0 to 70° C. can be suppressed to 10 pm or less. Therefore, if the wavelength control module of the present invention using this optical resonator is applied to a wavelength control system for the LD light source, the emission wavelength of the LD light source can be controlled highly accurately. As a result, the variation margin of the emission wavelength of the LD light source can be suppressed, and hence a requirement for coping with an increase in density of the wavelength interval up to 25 to 50 GHz in the WDM mode can be satisfied. Moreover, since a temperature sensor is not required in the wavelength control module, small size and low cost of the wavelength control module can be realized.

A third aspect, which makes it possible to measure the variation in the intensity of the transmitted light of the wavelength control module due to a change in the emission wavelength of the LD light source highly accurately, will be described in detail below.

FIG. 15 shows a first embodiment of the wavelength control module in the third aspect of the present invention. FIG. 15 is a schematic block diagram showing an example of a wavelength control system for the LD light source, wherein reference symbol 310 denotes a wavelength control module, and 314 denotes an optical resonator. In FIG. 15, the optical resonator has the same structure as those shown in FIGS. 11A and 11B.

A largely different point of a wavelength control module 310 in this aspect from the conventional wavelength control module is that a condensing device 312 is provided between an optical resonator 314 and a first optical diode (detection device) 315.

The condensing device 312 is for condensing the transmitted light emitted from the optical resonator 314 into a detection area 15a on the light-receiving plane of the first optical diode 315, and as a specific example, a condenser lens such as an aspherical lens, a concave mirror and the like can be used.

The condensing device 312 is constructed such that, for example as shown in FIG. 16A, the irradiation area 330a of the transmitted light condensed by the condensing device 312 is included completely in the detection area 315a, on the light-receiving plane of the first optical diode 15. Preferably, it is desired that the irradiation area 330a of the transmitted light is located substantially in the middle of the detection area 315a, at the time of initial setting. Moreover, it is desired that the area of the irradiation area 330a is smaller than that of the detection area 315a, and for example, is ½ or less of the area of the detection area 315a. If the area of the irradiation area 330a is larger than ½ of the area of the detection area 315a, when a misregistration of the optical resonator 314 occurs due to a temperature change, as shown in FIG. 16B, there is the large possibility that a part of the irradiation area 330a of the transmitted light comes out of the detection area 315a. However, if the irradiation area 330a of the transmitted light is too small, the power density of the transmitted light irradiated onto the light-receiving plane of the first optical diode 315 becomes too big, and may exceed a measurement limit of the first optical diode 15. Therefore, the irradiation area 330a of the transmitted light is set such that the power density of the transmitted light irradiated onto the light-receiving plane corresponding to the power of the monitoring optical signal does not exceed the measurement limit of the first optical diode 315, and for example, such that the area of the irradiation area 330a is not smaller than ⅕ of the area of the detection area 315a.

In this aspect, a condenser lens is used for the condensing device 312, and for example, it is desired to use a condenser lens having substantially the same focal length as that of a lens used in the collimator 12, which emits the monitoring optical signal as parallel light.

If the focal length of the condenser lens 312 is too long, the distance between the condenser lens 312 and the first optical diode 315 becomes long, and as a result, the whole wavelength control module 310 becomes large. On the other hand, if the focal length is too short, the distance between the condenser lens 312 and the first optical diode 315 becomes too short, and hence the wiring in the optical diode 315 may come in contact with the condenser lens. Therefore, it is desired that the focal length of the condenser lens 312 be from 1.8 to 4.0 mm.

For the optical resonator 314 in the third aspect, an optical resonator having the same structure as that of the optical resonator 214 shown in FIGS. 11A and 11B, or FIGS. 12A and 12B in the second aspect is used.

In the optical resonator 314, the opposite end faces 214a and 214b perpendicular to the thickness direction (lamination direction) become a plane of incidence and an outgoing plane of the light, respectively, and the medium inside the hollow part 222 is an atmospheric layer.

Also in this embodiment, the hollow part 222 communicates with the outside of the optical resonator 314 by the grooves 225, and hence the hollow part (atmospheric layer) 222 is open. As a result, even if the temperature changes, a pressure difference does not occur between the inside and the outside of the hollow part (atmospheric layer) 222, and hence there is no possibility that the bonding at the joint portion between the substrates 231, 231′and the spacer 233 is damaged.

In this aspect, as shown in FIG. 15, the optical path from the collimator (input device) 312 to the first optical diode 315, and the optical path from the collimator (input device) 312 to the second optical diode 317 are housed in a sealed housing (not shown).

As in the embodiment shown in FIGS. 11A and 11B, a fixing member 241 with the planar shape being substantially in a letter C shape is provided on the inner face of the housing, and an optical resonator 234 (corresponding to the optical resonator 214 in FIG. 11) is arranged in the fixing member 241, so that the bottom face thereof which is parallel with The traveling direction of light comes in contact with the inner face of the housing. Moreover, since the optical resonator is fixed to the housing and the fixing member by an adhesive, a deviation of the constituents is prevented from occurring.

Furthermore, as in the optical resonator 214 shown in FIGS. 11A and 11B, in the optical resonator 314 in this aspect, the spacer 233 is formed from a material having a coefficient of linear expansion of almost zero, that is, a material having a coefficient of linear expansion of from about −0.02×10⁻⁶/K to +0.02×⁻⁶/K, such as Zerodur (trademark) and ULE (trademark).

According to the third aspect, when the air temperature changes, even if the position where the optical resonator 114 is fixed is shifted due to a difference in the coefficient of linear expansion of respective members, for example, the housing, the adhesive and the optical resonator, since the condenser lens 312 is provided, as shown in FIG. 15, between the optical resonator 314 and the first optical diode 315, the transmitted light of the optical resonator 314 is irradiated into the detection area 315a of the first optical diode 315 without any loss, as shown in FIG. 16A.

As a result, a change in the intensity of the transmitted light measured by the first optical diode 315 resulting from a variation of the fixed position of the optical resonator 114 is suppressed, thereby improving the detection accuracy of a variation in the emission wavelength of the LD light source 1 by means of the wavelength control module 310.

Moreover, the refractive index n of the medium (in this aspect, the atmospheric layer) may change due to a change in the air temperature. However, since the spacer 233 is formed from a material having a coefficient of linear expansion of almost zero, changing of the gap length d accompanying temperature change can be prevented. Furthermore, in the optical resonator 314, since the hollow part is open, the density of the medium in the hollow part 222 is constant at all times, and hence the refractive index of the medium can be kept constant at all times.

As described above, in this aspect, a change in the transmission characteristic of the optical resonator 314 due to a temperature change can be suppressed, by using the optical resonator having the configuration shown in FIG. 11, thereby improving the detection accuracy of a variation in the emission wavelength of the first LD light source 1 by means of the wavelength control module 310.

Moreover, the optical resonator 314 (corresponding to the optical resonator 214 in the second aspect) may be fixed to the fixing member 241 using a resilient member 244, by using the optical resonator having the configuration shown in FIG. 12. In other words, if the resilient member 244 is used as the means for fixing the optical resonator 314 to the fixing member 341, the influence due to a difference in the coefficient of linear expansion of each member, such as the housing, the adhesive, and the optical resonator, decreases, and hence a shift of the fixed position of the optical resonator 314 resulting from a temperature change can be suppressed, thereby improving the reliability.

Specific examples in the third aspect will be described below.

### EXAMPLE 4

The optical resonator 314 (corresponding to 114 in FIG. 2) was manufactured by the same manufacturing method as in Example 1, using the manufacturing method shown in FIG. 2.

The obtained optical resonator 314 was used to prepare a wavelength control module 110 having the configuration shown in FIG. 15. The optical path from the collimator 12 (input device), passing through the optical resonator 314 and reaching the first and second optical diodes 315 and 317 (detection device) was housed in a sealable housing.

An aspherical lens having a focal length of 1.8 mm was used for the condenser lens 312, and the fixed position of the condenser lens 112 was determined so that the area of the irradiation area of the transmitted light becomes ½ of the area of the detection area, on the light-receiving plane of the first optical diode 15, and the irradiation area is located substantially in the middle of the detection area.

This wavelength control module 310 was used to constitute a wavelength control system for the LD light source 1 as shown in FIG. 15.

### TEST EXAMPLE 10

The wavelength control system constructed in Example 4 was used to control the emission wavelength of the LD light source 1.

The emission wavelength of the LD light source 1 was set to be constant at 1550.116 nm. The output value (unit: A/W) of the first optical diode 15 was measured, and a value (unit: nm) obtained by converting the output value of the first optical diode 15 to a wavelength based on the transmission characteristic of the optical resonator 114 was determined. A change in the output value of the first optical diode 315 when the environmental temperature was increased from −5° C. to 70° C., and then dropped from 70° C. to −5° C. is shown by the solid line in FIG. 17, and a change in wavelength is shown by the solid line in FIG. 18.

There is no substantial difference between at the time of temperature rise and at the time of temperature drop, and substantially similar measurement results were obtained.

### TEST EXAMPLE 11

A wavelength control module was prepared in the same manner as in Example 1, except that the condenser lens 112 was not provided, to constitute a wavelength control system for the LD light source 1 as shown in FIG. 19.

The emission wavelength of the LD light source 1 was controlled in the same manner as in Test Example 10. A change in the output value of the first optical diode 15 when the environmental temperature was increased from −5° C. to 70° C., and then dropped from 70° C. to −5° C. is shown by the broken line in FIG. 17, and a change in wavelength is shown by the broken line in FIG. 18.

There is no substantial difference between at the time of temperature rise and at the time of temperature drop, and substantially similar measurement results were obtained.

From the results shown in FIG. 17 and FIG. 18, the output of the first optical diode 15 was nearly the same in Test Example 1 and Test Example 2, and the value obtained by converting the output into wavelength substantially agreed with the emission wavelength of the LD light source 1.

On the other hand, in Test Example 11 in which the condenser lens was not provided, the output of the first optical diode 15 changed about 10% based on a value at 30° C., due to temperature changes of from −5 to 70° C. As a result obtained by converting this to wavelength, though the emission wavelength of the LD light source 1 was actually constant, the wavelength of the monitoring optical signal entering the optical resonator 114 apparently changed 35 pm.

On the other hand, in Test Example 10 in which the condenser lens 112 was provided, the output change of the first optical diode 15 due to temperature changes of from −5 to 70° C. was suppressed to 3% or less based on the value at 30° C. As a result obtained by converting this to wavelength, the apparent wavelength change was suppressed to 7 pm or less.

As described above, according to the third aspect of the present invention, since the condenser lens for condensing the transmitted light from the optical resonator into the detection area of the detection device is provided between the optical resonator and the detection device in the wavelength control module, a change in the intensity of the transmitted light resulting from a deviation between the detection area of the detection device and the irradiation area of the transmitted light of the optical resonator can be suppressed. As a result, the detection accuracy of a variation in the emission wavelength of the LD light source by means of the wavelength control module can be improved.

A fourth aspect, whose object is to construct a wavelength control module capable of coping with an increase in density of the emission wavelength in the WDM, will be described below in detail.

FIG. 19 is a schematic block diagram showing an example of constructing a wavelength control system using the wavelength control module according to the fourth aspect.

A largely different point of a wavelength control module 431 in the fourth aspect from the conventional wavelength control module shown in FIG. 25 is that an optical resonator 434 used in this aspect comprises correction devices 435 and 436, which selectively invert and output the sign of an intensity variation value of the transmitted light from the optical resonator 434 and an intensity variation value of the reflected light from a half mirror 413, with respect to the monitoring optical signal having a specified wavelength. In FIG. 19, members other than the wavelength control module are denoted by the same reference symbols as those in FIG. 25, and description thereof is omitted.

As shown in FIG. 19, in the fourth aspect, the outgoing beam from the LD light source 1 is branched into two by a first coupler 2. By this first coupler 2, for example, 95% of the outgoing beam is input to the transmission optical fiber as a signal light, and the remaining 5% is input to the wavelength control module 431 as a monitoring optical signal.

In the wavelength control module 431, the monitoring optical signal is input to the half mirror 413 as parallel light by a collimator 412, and the transmitted light from the half mirror 413 is input to the optical resonator 434, and the intensity of the transmitted light from the optical resonator 434 is measured by a first optical diode 415. On the other hand, the reflected light from the half mirror 413 is guided to a second optical diode 417 via a reflecting mirror 416, and the optical intensity thereof is measured.

Generally, the transmission characteristic of the optical resonator is expressed by the above equation (1), and if it is expressed by a graph in which the wavelength is plotted on the X axis and the transmittance is plotted on the Y axis, a graph in which a mountain-shaped distribution of a certain shape as shown in FIG. 20 is continuous is obtained. One mountain-shaped distribution is symmetric, and two wavelengths having equal transmittance exist on either side of the central wavelength. The inclination of the mountain-shaped distribution at the two points having the equal transmittance has opposite signs and the same absolute value.

Moreover, as shown in FIG. 21, the optical resonator 434 is designed such that the interval ΔP between the central wavelength is equal to the interval of wavelengths (λ1, λ2, λ3, . . . ) of the outgoing beam from the LD light source 1, that is, twice the wavelength interval Δλ of the monitoring optical signal entering the optical resonator 434 (Δλ=ΔP/2), and the full width at half maximum (FWHM) of the optical resonator 34 becomes equal to the wavelength interval Δλ of the monitoring optical signal. Here, the full width at half maximum stands for a width (wavelength interval) where the transmittance in the mountain-shaped distribution becomes ½ of the peak value (TO).

Moreover, the transmittance in a plurality of wavelengths (λ1, λ2, λ3, λ4, λ5, λ6, . . . ) emitted from the LD light source 1 is set to be ½ (TO/2) of the peak value, respectively.

In this embodiment, of the plurality of wavelengths (λ1, λ2, λ3, λ4, λ5, λ6, . . . ) emitted from the LD light source 1, the odd number wavelengths (λ1, λ3, λ5, . . . ) counted in order from the shorter wavelength are located on the shorter wavelength side than the central wavelengths (P1, P2, . . . ), and the even number wavelengths (λ2, λ4, λ6, . . . ) are located on the longer wavelength side than the central wavelengths P1, P2, . . . in one mountain-shaped distribution.

As shown in FIG. 19, the intensity of the transmitted light from the optical resonator 434 is measured by the first optical diode 415 and output as an electric signal. When a variation occurs in the wavelength of the monitoring optical signal, the intensity of the transmitted light measured by the first optical diode 415 changes, and appears as a change in the electric signal output therefrom. However, in this embodiment, of the plurality of wavelengths (λ1, λ2, λ3, λ4, λ5, λ6, . . . ) emitted from the LD light source 1, a variation value of the intensity of the transmitted light corresponding to the wavelength change is different between the odd number wavelengths (λ1, λ3, λ5, . . . ) and the even number wavelengths (λ2, λ4, λ6, . . . ).

In other words, in the mountain-shaped distribution indicating the transmission characteristic of the optical resonator 434, in the odd number wavelengths (λ1, λ3, λ5, . . . ) located on the shorter wavelength side than the central wavelengths (P1, P2, . . . ), the sign of inclination of the mountain-shaped distribution is positive (+). Therefore, when the normal transmittance is TO/2, and if the wavelength of the monitoring optical signal is shifted toward the longer wavelength side and the transmittance becomes larger than TO/2, the sign of the variation value of the intensity of the transmitted light becomes positive (+). On the contrary, when the wavelength of the monitoring optical signal is shifted toward the shorter wavelength side and the transmittance becomes smaller than TO/2, the sign of the variation value of the intensity of the transmitted light becomes negative (−).

On the other hand, in the even number wavelengths (λ2, λ4, λ6, . . . ) located on the longer wavelength side than the central wavelength (P1, P2, . . . ), the sign of the inclination of the mountain-shaped distribution is negative (−). Therefore, when the normal transmittance is TO/2, and if the wavelength of the monitoring optical signal is shifted toward the longer wavelength side and the transmittance becomes smaller than TO/2, the sign of the variation value of the intensity of the transmitted light becomes negative (−). On the contrary, when the wavelength of the monitoring optical signal is shifted toward the shorter wavelength side and the transmittance becomes larger than TO/2, the sign of the variation value of the intensity of the transmitted light becomes positive (+).

In this aspect, therefore, the correction device 435 is provided in the subsequent stage of the first optical diode 415, so that only when the wavelength of the outgoing beam of the LD light source 1, that is, the wavelength of the monitoring optical signal input to the optical resonator 434 is one of the odd number wavelengths (λ1, λ3, λ5, . . . ), is the sign of the variation value of the intensity of the transmitted light measured by the first optical diode 15 inverted and output.

The correction device 435 can be constructed so as to electrically correct by inversion the sign of the electric signal output from the first optical diode 415 corresponding to the variation value of the intensity of the transmitted light, only when the wavelength of the monitoring optical signal is one of the odd number wavelengths (λ1, λ3, λ5, . . . ).

The intensity of the outgoing beam of the LD light source 1 may change with lapse of time, and in this case, even if the wavelength of the outgoing beam is maintained at a certain wavelength, the intensity of the transmitted light measured by the first optical diode 415 changes. With respect to this problem, since the value obtained by measuring the intensity of the reflected light from the half mirror 413 by the second optical diode 417 changes corresponding to a variation in the intensity of the outgoing beam from the LD light source 1, if arithmetic processing is carried out so as to take a difference between, a variation value of the intensity of the transmitted light measured by the first optical diode 415 and a variation value of the intensity of the reflected light measured by the second optical diode 417, then of the variation values of the intensity of the transmitted light measured by the first optical diode 415, the variation value of the intensity of the transmitted light due to a change in the intensity of the outgoing beam is compensated for. As a result, the variation value of the intensity of the transmitted light due to a wavelength change of the outgoing beam can be known.

However, in this embodiment, when the wavelength of the outgoing beam from the LD light source 1, that is, the wavelength of the monitoring optical signal input to the optical resonator 434 is one of the odd number wavelengths (λ1, λ3, λ5, . . . ), the sign of the variation value of the intensity of the transmitted light measured by the first optical diode 415 is inverted and output. Therefore, the configuration in this embodiment is such that, with regard to the odd number wavelengths, the sign of the variation value of the intensity of the reflected light measured by the second optical diode 417 is also inverted and output.

Specifically, the correction device 436 is provided in the subsequent stage of the second optical diode 417, so that only when the wavelength of the monitoring optical signal is one of the odd number wavelengths (λ1, λ3, λ5, . . . ), is the sign of the electric signal output corresponding to the variation value of the intensity of the reflected light electrically corrected by inversion.

The variation value of the intensity of the transmitted light and the variation value of the intensity of the reflected light of the optical resonator 434 output through the correction device 435 and the correction device 436, respectively, are input to the arithmetic unit 5, where arithmetic processing for taking a difference between these is carried out.

The control unit 6 performs wavelength control by controlling the temperature controller in the LD light source 1 or the LD introduced current, based on the variation value of the intensity of the transmitted light after the arithmetic processing, so that the wavelength of the outgoing beam from the LD light source 1 returns to the normal wavelength preliminarily set, that is, so that the variation value of the intensity of the transmitted light after the arithmetic processing becomes zero.

In the wavelength range forming one mountain-shaped distribution in the graph showing the transmission characteristic of the optical resonator 434, the wavelength (wavelength of the monitoring optical signal) used for the wavelength control has heretofore been only one, but according to this aspect, one wavelength on the right side and one on the left side of the central wavelength in the mountain-shaped distribution, in total, two wavelengths can be used. As a result, the wavelength-controllable wavelength interval can be reduced, without extending the cavity length of the optical resonator 434, that is, without changing the transmission characteristic of the optical resonator 434.

Therefore, even if the density of the wavelength interval in the WDM mode increases, and the wavelength interval (Δλ) of the optical signal having a plurality of wavelengths oscillated from the LD light source 1 decreases, the wavelength control can be performed without increasing the size of the optical resonator 434.

Conventionally, as shown in FIG. 25 and FIG. 26, an optical resonator having an interval ΔP between the central wavelengths equal to the wavelength interval Δλ of the outgoing beam from the LD light source 1 must be used for the optical resonator 14 constituting the wavelength control module 11. In this embodiment, however, as is obvious from FIG. 19 and FIG. 20, in the optical resonator 434 constituting the wavelength control module 431, it is only necessary that ΔP/2 is equal to Δλ. Therefore, the inclination of the graph indicating the transmission characteristic of the optical resonator 34 is more gradual in this embodiment than in the conventional optical resonator, and since ΔP=2Δλ, the variation margin of the detectable wavelength is doubled.

Moreover, even if the wavelength interval (Δλ) of the optical signal having a plurality of wavelengths emitted from the LD light source 1 is not reduced, it is possible to shorten the cavity length of the optical resonator 434 to half, by having a configuration such that one wavelength each on the right and left sides of the central wavelength in the mountain-shaped distribution is used as the wavelength of the monitoring optical signal.

As a result, production of the optical resonator 434 in this aspect becomes easy, thereby enabling cost reduction and mass-production, as well as improving the reliability of the optical resonator 434, thereby improving the reliability of the whole wavelength control module 431.

The controllable wavelength interval (Δλ) in the wavelength control module 431 in this aspect can be reduced within a range that can reduce the interval between the central wavelengths (ΔP), by the manufacturing technique for the optical resonator 14, and for example, can correspond to a wavelength interval in a range of from 0.2 to 0.8 nm.

In this aspect, description has been given, assuming that of the plurality of wavelengths (λ1, λ2, λ3, λ4, λ5, λ6, . . . ) emitted from the LD light source 1, the odd number wavelengths (λ1, λ3, λ5, . . . ) counted in order from the shorter wavelength are located on the shorter wavelength side than the central wavelengths (P1, P2, . . . ), and the even number wavelengths (λ2, λ4, λ6, . . . ) are located on the longer wavelength side than the central wavelengths P1, P2, . . . . On the contrary, the odd number wavelengths may be located on the longer wavelength side than the central wavelengths, and the even number wavelengths may be located on the shorter wavelength side than the central wavelengths, and in a similar manner, the emission wavelength from the LD light source 1 can be controlled.

The correction devices 435 and 436 shown in FIG. 19 may be included in the arithmetic unit 5, or in the control unit 6.

Moreover, for the wavelength of the monitoring optical signal, it is possible to use an optional wavelength (first wavelength) on the shorter wavelength side than the central wavelength, and an optional wavelength (second wavelength) on the longer wavelength side than the central wavelength in the wavelength range forming the mountain-shaped distribution. However, particularly if the first wavelength and the second wavelength are selected so that the absolute values of the inclination of the graph in both wavelengths become equal, the variation in transmittance corresponding to the shift of wavelength of the monitoring optical signal becomes equal in both wavelengths, and hence the arithmetic processing becomes easy.

According to the fourth aspect of the present invention, control of two wavelengths in the wavelength range of at least one mountain-shaped distribution is possible, but a plurality of monitoring optical signals having at least four wavelengths, with the wavelength interval being Δλ, can be controlled, by designing such that the wavelength interval Δλ of the monitoring optical signal becomes equal to ½ of the interval ΔP of the central wavelengths (that is, ΔP/2) in the continuous mountain-shaped distribution.

Particularly, if it is designed such that the wavelength interval Δλ between the first wavelength and the second wavelength in one mountain-shaped distribution correspond to the full width at half maximum (FWHM) of the optical resonator, then both of the transmittance value at normal situation and the variation in transmittance corresponding to the shift of wavelength of the monitoring optical signal become equal in both wavelengths, and hence the arithmetic processing becomes easier.

An example in this aspect was prepared, and compared with an other comparative example.

### EXAMPLE 5

A wavelength control module 431 having the correction devices 435 and 436 as shown in FIG. 19 was prepared, to constitute a wavelength control system.

Optical signals of eight channels multiplexed with a wavelength interval of λ1=1550.12 nm, λ2=1550.52 nm, . . . and 50 GHz (0.4 nm) were emitted from the LD light source, and the angle of incidence θ of the monitoring optical signal in the optical resonator 434 was set to 90°.

For the optical resonator 434 constituting the wavelength control module 431, one having the same sectional structure as that shown in FIG. 2 as the conventional optical resonator was used, and the structural parameters were as follows.

Cavity length d: 1.5 mm

Material of medium 22: air (refractive index=1.0)

Material of reflecting coating 21: Ta₂O₅, SiO₂ (reflectance=26.14%)

Peak value TO in transmittance: 95%

Transmission when λ1 is 1550.12 nm: 47.5%

Full width at half maximum (FWHM) when angle of incidence θ is 90°: 0.4 nm.

According to the wavelength control system using the wavelength control module 431 in this Example, the outgoing beam from the LD light source could be controlled at a sensitivity as high as 8 pm.

### COMPARATIVE EXAMPLE 1

A wavelength control module 11 having the same configuration as that shown in FIG. 25, being the conventional wavelength control module, was prepared, to constitute a wavelength control system. The correction device was not provided.

Optical signals of eight channels multiplexed with a wavelength interval of λ1=1550.12 nm, λ2=1550.52 nm, . . . and 50 GHz (0.4 nm) were emitted from the LD light source, and the angle of incidence θ of the monitoring optical signal in the optical resonator 434 was set to 90°.

For the optical resonator 14 constituting the wavelength control module 11, one having the sectional structure as shown in FIG. 26 was used, and the structural parameters were as follows.

Cavity length d: 3.0 mm

Material of medium 22: air (refractive index=1.0)

Material of reflecting coating 21: Ta₂O₅, SiO₂ (reflectance=29.53%)

Peak value TO in transmittance: 95%

Transmission when λ1 is 1550.12 nm: 47.5%

Full width at half maximum (FWHM) when angle of incidence θ is 90°: 0.18 nm.

According to the wavelength control system using the wavelength control module 11 in this Example, the outgoing beam from the LD light source could be controlled at nearly the same sensitivity as in Example 1, but the cavity length d of the optical resonator 14 had to be almost doubled as compared with that in Example 5.

Moreover, in Comparative Example 1, the full width at half maximum of the optical resonator is smaller, as compared with Example 5, and the variation margin of a wavelength detectable by the wavelength control module is ½ of that in Example 5, from the graph indicating the transmission characteristic.

As described above, according to the fourth aspect, in the wavelength range forming the mountain-shaped distribution in the graph indicating the transmission characteristic of the optical resonator, by using both the first wavelength on the shorter wavelength side than the central wavelength and the second wavelength on the longer wavelength side than the central wavelength as the wavelength of the monitoring optical signal, then even if the wavelength interval of the monitoring optical signal is the same as that of the conventional optical resonator, the cavity length of the optical resonator can be reduced to half the length of the conventional optical resonator.

When the wavelength interval is reduced more than that of the conventional optical resonator, it is possible to perform highly sensitive wavelength control, without increasing the cavity length of the optical resonator. In this case, since the optical resonator does not become large, it is not difficult to prepare the optical resonator, and the reliability thereof does not deteriorate. It is also desirable for mass-production and cost reduction.

As a result, highly sensitive wavelength control can be performed by using the optical resonator of a low cost and having high reliability, without causing an increase in the size of the optical resonator, with respect to an increase in density of the wavelength interval in the WDM mode.

A fifth aspect will be described below, in which the configuration of the optical resonator is changed for constructing an optical resonator capable of coping with an increase in density of the wavelength interval, being the same object as in the fourth aspect, and also capable of reducing the size.

FIG. 22 and FIG. 23 show a first embodiment in the fifth aspect. FIG. 22 is a schematic block diagram of a wavelength control system using a wavelength control module 530, and FIG. 23 is a cross section of an optical resonator 531 according to the fifth aspect.

A largely different point of the wavelength control module 530 in the fifth aspect as shown in FIG. 23 from the conventional wavelength control module 11 as shown in FIG. 25 is that the optical resonator 531 having a function as a half mirror is provided instead of the conventional half mirror 13 and optical resonator 14.

The optical resonator 531 in the first embodiment as shown in FIG. 23 comprises two substrates 532, 533 and a spacer 536 intervened between these substrates 532 and 533. The substrates 532 and 533 are formed of a transparent material such as glass, and reflecting coatings 534, 535 are respectively formed on the inside end faces 532a and 533a of the opposite end faces in the thickness direction. The reflecting coatings 534, 535 on the inside end faces 32a and 33a are formed of a metal thin film or a dielectric multilayer film comprising TiO₂ or Ta₂O₅ and SiO₂, and hence, the inside end faces 532a and 533a of both substrates 532 and 533 become a reflecting surface having a reflectance of from 40 to 90%. The reflectance of the inside end faces of both substrates 532a and 532b is equal, and in this embodiment, the reflectance is 90%.

In this embodiment, one substrate 532 is formed such that the outside end face 532b is inclined with respect to the inside end face 532a, and a semi-transparent film 537 is formed on the outside end face 532b. The semi-transparent film 537 on the outside end face 532b is formed of, for example, a metal thin film or a dielectric multilayer film comprising TiO₂ or Ta₂O₅ and SiO₂, so that it reflects a part of the light incident onto the outside end face 532b and transmits the remainder. The reflectance on the outside end face 32b of the one substrate 532 is preferably from 10 to 50%, and more preferably 33%.

The angle of inclination θ1 of the outside end face 532b with respect to the inside end face 532a of the one substrate 532 is set such that the reflected light on the outside end face 532b is appropriately input to the second optical diode 517 through the optical part in the subsequent stage, in this embodiment, the reflecting mirror 516, and the transmitted light through the outside end face 532b is appropriately input to the first optical diode 515 through the one substrate 532, the medium 538 and the other substrate 533. The angle of inclination θ1 of the outside end face 532b is preferably formed to be within a range of from 5 to 20°, and in this embodiment 10°.

The other substrate 533 has a uniform thickness, and the inside end face 533a and the outside end face 533b are parallel with each other. Preferably a reflection preventing film is formed on the outside end face 533b of the other substrate 533.

The spacer 536 is provided so that the distance between both substrates 532 and 533 facing each other with the medium 538 therebetween, that is, the cavity length d does not change, and the opposite end faces of the spacer 536 in the thickness direction are joined and integrated with both substrates 532 and 533.

In this aspect, the medium 538 is an atmospheric layer, and the spacer 536 is formed in a block having a hollow part 536a penetrating therethrough in the thickness direction. The thickness of the spacer 536 is uniform, and the inside end faces 532a and 533a of both substrates 532 and 533 are parallel with each other.

Therefore, in this aspect, the outside end face 532a of the one substrate 532 inclines at an angle of inclination of 20° with respect to the outside end face 533b of the other substrate 533.

Preferably the hollow part 536a of the spacer 536 communicates with the outside of the optical resonator 531 by a groove or a hole, and the atmospheric layer 538 in the optical resonator 531 is open. If the atmospheric layer 538 in the optical resonator 531 is an open system, then when the temperature changes, a pressure difference does not occur between the inside and the outside of the optical resonator 531, and as a result, there is no possibility that the bonding at the joint portion between the substrates 532 and 533 and the spacer 536 is damaged.

As shown in FIG. 23, the optical resonator 531 in this embodiment is formed and used such that the outside end face 532b of the one substrate 532 becomes a plane of incidence of light, and the outside end face 533b of the other substrate 533 becomes an outgoing plane.

When a wavelength control module is constructed by using the optical resonator 531 in the first embodiment shown in FIG. 23, the optical resonator 531 is positioned and fixed such that, of the parallel light from the collimator 512 input to the outside end face 532b of the one substrate 532 of the optical resonator 531, the reflected light reflected by the outside end face 532b passes via the reflecting mirror 516 and is appropriately input to the second optical diode 517, and of the parallel light, the transmitted light having passed through the outside end face 532b of the one substrate 532 of the optical resonator 531, passed through the atmospheric layer (medium) 538 inside of the optical resonator 531, and been emitted from the outside end face 533b of the other substrate 533 is appropriately input to the first optical diode 515.

Though not shown, a condenser lens may be provided, according to need, on the optical path from the outgoing plane of the optical resonator 531 (the outside end face 533b of the other substrate 533) to the first optical diode 515.

The optical resonator 531 in this embodiment can be prepared for example by the following manner. That is to say, the one substrate 532 having a reflecting coating 534 formed on one face (inside end face 532a) thereof, and the other substrate 533 having a reflecting coating 535 formed on one face (inside end face 533a) thereof are prepared, and the other face of the one substrate 532 (the outside end face 532b) is incline polished, and thereafter, the semi-transparent film 537 is formed on the face by a film-forming method such as vapor deposition.

The spacer 536 in a block form, having the hollow part 536a passing therethrough in the thickness direction is also prepared, and the inside end faces 532a and 533a of the two substrates 532 and 533 are respectively adhered on the opposite end faces of the spacer 536 in the thickness direction, to thereby obtain the optical resonator 531.

Alternatively, after preparing a constitution by joining and integrating the spacer 536, and the one substrate 532 before being incline polished and the other substrate 533, the outside end face 532b of the one substrate 532 may be incline polished, and the semi-transparent film 537 then formed on the face.

According to this aspect, since the incident end face of the optical resonator 531, that is, the outside end face 532b of the one substrate 532 has the optical function as the half mirror, it is not necessary to provide the half mirror 13 provided in the previous stage of the optical resonator 14 in the conventional wavelength control module 11 for example as shown in FIG. 26. Therefore, it is possible to shorten the distance from the collimator 512 to the first optical diode 515 in the optical resonator 531 shown in FIG. 23, and as a result, the wavelength control module 530 can be made small. Moreover, even in a case where the cavity length d of the optical resonator 531 is more than that of the conventional optical resonator, in order to cope with an increase in density of the wavelength interval in the WDM mode, the distance from the collimator 512 to the first optical diode 515 can be made smaller than that of the conventional optical resonator. As a result, it becomes possible to house the component parts of the wavelength control module in a housing or a board having the same size as or a smaller size than the conventional one.

In the wavelength control module 530 in this example, the number of parts can be less than in the conventional wavelength control module, and hence cost reduction is possible, and the assembly operation is also reduced to thereby improve production efficiency.

A second embodiment according to the fifth aspect will be described below. In the wavelength control module in this embodiment, an optical resonator 541 shown in FIG. 24 is used instead of the optical resonator 531 in the first embodiment, and the other configuration is the same.

A different point of the optical resonator 541 in this embodiment from the first embodiment of the fifth aspect is that the thickness of a medium 548 in a hollow part 546a gradually changes, and an inside end face 542a of one substrate 542 is inclined with respect to an inside end face 543a of the other substrate 543.

In other words, the optical resonator 541 in the second embodiment comprises two substrates 542 and 543 arranged so as to face each other, and a spacer 546 intervened between these substrates 542 and 543. Both substrates 542 and 543 are formed of a transparent material such as glass, and reflecting coatings 544 and 545 are respectively formed on the inside end faces 542a and 543a, as in the first embodiment.

An outside end face 542b of the one substrate 542 inclines with respect to the inside end face 542a, so that the thickness thereof gradually decreases along one direction perpendicular to the thickness direction. Moreover, a semi-transparent film 547 is formed on the outside end face 542b of the one substrate 542, as in the first embodiment.

The other substrate 543 has a uniform thickness, and the inside end face 543a and the outside end face 543b are parallel with each other.

In the second embodiment of the fifth aspect, the spacer 546 is formed in a block form, having the hollow part 546a passing therethrough in the thickness direction, so that the thickness gradually decreases along the one direction perpendicular to the thickness direction (d2−d1), and an other end face 546c inclines with respect to one end face 546b. The direction in which the thickness of the spacer 546 gradually decreases, and the direction in which the thickness of the one substrate 542 gradually decreases are the same.

The angle of inclination of the other end face 546c with respect to the one end face 546b is preferably set within a range of from 0.01° to 0.5°, and in this embodiment, is formed at 0.06°.

The angle of inclination of the outside end face 542b of the one substrate 542 with respect to the outside end face 543b of the other substrate 543 is set such that light having passed through the semi-transparent film 547, the one substrate 542, and the reflecting coating 544 on the inside end face 542a thereof becomes perpendicular to the inside end face 543a of the other substrate 543, and when the direction of the optical resonator 41 is finely adjusted in a direction rotating about the central axis perpendicular to the page in FIG. 22, the light reflected by the semi-transparent film 547 is appropriately input to the second optical diode 17. Preferably, the angle of inclination of the outside end face 542b of the one substrate 542 is set within a range of from 5° to 200. In this second embodiment, the outside end face 542b of the one substrate 542 inclines with respect to the inside end face 542a of the one substrate at an angle of 10°, and as a whole, the angle of inclination of the outside end face 542b of the one substrate 542 with respect to the outside end face 543b of the other substrate 543 is formed at 10.06°.

The optical resonator 541 in the second embodiment is arranged and used such that the outside end face 542b of the one substrate 542 becomes a plane of incidence of light, and the outside end face 543b of the other substrate 543 becomes an outgoing plane, so that the optical resonator 541 can form a wavelength control module in the same manner as in the first embodiment.

According to the second embodiment of the fifth aspect, since the outside end face 542b of the one substrate 542 of the optical resonator 541 has the optical function as a half mirror, the same working effect as that of the first embodiment can be obtained. In other words, in the wavelength control module 530 shown in FIG. 22, since it is not necessary to provide the half mirror 13 provided in the conventional wavelength control module shown in FIG. 25, the wavelength control module 530 can be made small as compared with the conventional wavelength control module. Even in a case where the cavity length d of the optical resonator 541 is more than that of the conventional optical resonator, in order to cope with an increase in density of the wavelength interval in the WDM mode, the component parts of the wavelength control module can be housed in a housing or a board having the same size as or a smaller size than the conventional one. Moreover, since the number of parts can be less than in the conventional wavelength control module, and hence cost reduction is possible, and the assembly operation is also reduced to thereby improve production efficiency.

Furthermore, in the optical resonator 541 in the second embodiment, the thickness of the spacer 546 is formed so as to gradually decrease along one direction perpendicular to the thickness direction (d2−d1). Therefore, since the thickness of the medium 548 inside the hollow part 546a gradually changes, then when the position of incidence of light to the hollow part 546a changes, the optical path length in the medium 548 changes. Therefore, at the time of positioning the optical resonator 541, the transmission characteristic of the optical resonator 541 can be changed, by changing the position of incidence of light on the plane of incidence (the outside end face 542b of the one substrate 542).

The effect of the present aspect will be clarified, by showing specific examples.

The optical resonator 531 having the configuration shown in FIG. 23 was prepared and used to construct a wavelength control module.

A square glass plate of a length of 4 mm, a width of 5 mm, and a thickness of 2 mm was used for two substrates 532 and 533. Reflecting coatings 534 and 535 comprising SiO₂ and TiO₂ or Ta₂O₅ were formed respectively on the inside end faces 532a and 533a of both substrates 532 and 533 by the ion assist vapor deposition method. The reflectance on the inside end faces 532a and 533a of both substrates 532 and 53-3 was set to 90%.

Moreover, the outside end face 532b of the one substrate 532 was incline polished with an angle of inclination of 20° with respect to the inside end face 532a, and then a semi-transparent film 537 comprising SiO₂ and TiO₂ or Ta₂O₅ was formed by the ion assist vapor deposition method. The reflectance on the outside end face 532b of the one substrate 532 was set to 50%.

Separately from the substrates, a hexahedral spacer 536 formed of Zerodur (trademark) having a length of 4 mm, a width of 5 mm, and a thickness of 3 mm was prepared. A hollow part 536a penetrating the spacer 536 in the thickness direction was cylindrical having an inner diameter of 2 mm, and formed by boring by the ultrasonic machining method.

After an adhesive was applied on the opposite end faces of the spacer 536 in the thickness direction, the inside end faces 532a and 533a of the substrates 532 and 533 were respectively overlapped on the opposite end faces of the spacer 536 and fixed by bonding, to thereby obtain the optical resonator 531.

The longest length in the thickness direction of the obtained optical resonator 531 was about 7 mm.

The obtained optical resonator 531 was used to manufacture the wavelength control module 530 shown in FIG. 27. The required distance from a collimator 512 to the optical resonator 531 was at least 16 mm, and the required distance from the optical resonator 531 to the optical diode 515 was at least 1 mm. Therefore, the distance from the collimator 512 to the optical diode 515 became 24 mm or more.

### COMPARATIVE EXAMPLE 2

An optical resonator 14 having the same configuration as the conventional optical resonator shown in FIG. 27 was prepared and used to construct the conventional wavelength control module 11 shown in FIG. 25.

The optical resonator 14 shown in FIG. 25 was constructed in the same manner as in Example 6. Reflecting coatings 21a and 21b were respectively formed on the inside end face of the two substrates 21, 21′. Incline polishing of the outside end face of the one substrate and formation of the semi-transparent film on this face were not performed. A spacer 23 the same as that of Example 1 was also prepared.

After an adhesive was applied on the opposite end faces of the spacer 23 in the thickness direction, the inside end faces of the substrates 21 and 21′ were respectively overlapped on the opposite end faces of the spacer and fixed by bonding, to thereby obtain the optical resonator 14.

The incident end face and the outgoing end face of the obtained optical resonator 14 were parallel with each other, and the length in the thickness direction was about 7 mm.

A wavelength control module 11 having the same configuration as that of the conventional wavelength control module shown in FIG. 25 was manufactured by using the obtained optical resonator 14. For the half mirror 13, one obtained by forming a semi-transparent film (reflectance: 50%) on one surface of the substrate having a thickness of 4 mm was used. The required distance from a collimator 12 to the half mirror 13 was at least 16 mm, the required distance from the half mirror 13 to the optical resonator 14 was at least 10 mm, and the required distance from the optical resonator 14 to the first optical diode 15 was at least 1 mm. Therefore, the distance from the collimator 12 to the optical diode 15 became 38 mm or more.

When assembling the wavelength control module, both operations of positioning of the optical resonator 14 and positioning of the half mirror 13 were necessary, and hence the number of processes was more than in Example 1.

As described above, according to the fifth aspect, an optical resonator in which the plane of incidence has an optical function as the half mirror can be obtained.

Therefore, if the optical resonator of the present invention is used in a wavelength control module having a configuration comprising the first measurement device which measures the intensity of the transmitted light of the optical resonator and the second measurement device which measures the intensity of the reference light which does not go through the optical resonator, then the half mirror which has been heretofore provided in the previous stage of the optical resonator is not required. As a result, the number of parts can be reduced, and the module can be made small, thereby enabling cost reduction.

Hence, even if the cavity length d of the optical resonator is increased in order to cope with an increase in density of the wavelength interval in the WDM mode, thus increasing the size of the optical resonator, the component parts of the wavelength control module can be housed in a housing or a board having the same size as or a smaller size than the conventional one.

In the conventional wavelength control module, complicated adjustment operation is required in order to determine the location of the half mirror and the optical resonator at the time of assembly, but if the optical resonator of the present invention is used, it is not necessary to provide the half mirror in the previous stage of the optical resonator. As a result, the workload at the time of assembly is reduced, thereby enabling cost reduction.

### INDUSTRIAL APPLICABILITY

The present invention relates to a wavelength optical resonator and a wavelength control module using the wavelength optical resonator. The wavelength optical resonator and the wavelength control module are ideally used in optical communication using a plurality of wavelengths for the wavelength-division multiplexing method.

1. An optical resonator comprising:
a spacer made from a material having a coefficient of linear expansion of almost zero, formed in a block with a specified thickness, and having a hollow part penetrating in the thickness direction, the hollow part communicating with the outside; and
two substrates joined on opposite end faces of the spacer in the thickness direction,
wherein a reflecting coating is provided at least on an area facing the inside of said hollow part, of the opposing faces of the two substrates.

2. An optical resonator according to claim 1, wherein said substrates and said spacer are joined by optical contact.

3. An optical resonator according to claim 2, wherein a profile irregularity on the joined faces of said substrate and said spacer is respectively λ/4, in the joint portion of said substrate and said spacer.

4. An optical resonator according to any one of claim 1 through claim 3, wherein the thickness of said spacer is constant.

5. An optical resonator according to claim 1, wherein said hollow part is filled with dry nitrogen or dry air.

6. A wavelength control module comprising:
the optical resonator according to claim 1;
a device which inputs a monitoring optical signal to one substrate of said optical resonator as parallel light;
a device which detects a change in the intensity of the transmitted light emitted from the other substrate of said optical resonator; and
a housing, which is capable of airtight sealing and which houses at least said optical resonator.

7. A wavelength control module according to claim 6, wherein an optical path from said input device, passing through said optical resonator and reaching said detection device is housed in said housing.

8. A wavelength control module according to claim 6, wherein inside of said housing is replaced by dry nitrogen or dry air.

9. A method of manufacturing an optical resonator in which two substrates arranged so as to face each other are joined on the opposite end faces of a spacer in the thickness direction, which has a hollow part penetrating in the thickness direction and is formed in a block, and a reflecting coating is provided at least on an area facing the inside of said hollow part, of the opposing faces of said two substrates, the method comprising the steps of:
forming said spacer by cutting a spacer base material formed in a plate form with a predetermined thickness, and having a plurality of hollow parts formed therein penetrating in the thickness direction, with adjacent hollow parts communicating with each other, in the thickness direction between said adjacent hollow parts.

10. A method of manufacturing an optical resonator according to claim 9 comprising the steps of:
before cutting said spacer base material, polishing the opposite end faces in the thickness direction of said spacer base material so that the surface irregularity becomes less than λ/4;
cutting a substrate base material, in which one surface is polished to have the surface irregularity of λ/4 or below, and a reflecting coating is formed on a part of the surface or over the whole surface, to thereby form said substrate; and
making said two substrates face each other so that the reflecting coating becomes inside, putting said spacer between said substrates and integrating said substrates and said spacer with optical contact.

11. A method of manufacturing an optical resonator according to claim 9 comprising the steps of:
making two substrate base materials having a reflecting coating formed on a part of one surface or over the whole surface face each other so that said reflecting coating becomes inside; obtaining a laminated body by inserting said spacer base material between said substrate base materials; and
cutting said laminated body in the thickness direction at an intermediate position between adjacent hollow parts of said spacer base material.

12. A method of manufacturing an optical resonator according to claim 11 comprising the steps of:
polishing the opposite end faces of said spacer base material in the thickness direction so as to have a surface irregularity of less than λ/4 before forming said laminated body; and polishing one surface, of the inner surfaces of the two substrate base materials, so as to have a profile irregularity of less than λ/4 before forming said reflecting coating, and
integrating said substrate base material and said spacer base material with optical contact before forming said laminated body.

13. A method of manufacturing an optical resonator according to claim 9 further comprising the steps of replacing the inside of said hollow part with dry nitrogen or dry air.

14. A wavelength control module comprising:
an optical resonator obtained by arranging two substrates, whose one face is made to be a reflecting surface having a specified reflectance, parallel with each other, so that said reflecting surfaces face each other with a medium therebetween, and intervening a spacer between said two substrates;
a device which inputs a monitoring optical signal to said optical resonator as parallel light; and
a device which detects a change in the intensity of the transmitted light from said optical resonator,
a housing for housing an optical path from said input device, passing through said optical resonator and reaching said detection device; and for fixing said optical resonator on the inner face, wherein a fixing member for suppressing movement of said optical resonator is provided on a inner surface of said housing.

15. A wavelength control module comprising: an optical resonator obtained by arranging two substrates, whose one face is a reflecting surface having a specified reflectance, parallel with each other, so that said reflecting surfaces face each other with a medium therebetween, and intervening a spacer between said two substrates; a device which inputs a monitoring optical signal to said optical resonator as parallel light; and a device which detects a change in the intensity of the transmitted light from said optical resonator, and an optical path from said input device, passing through said optical resonator and reaching said detection device is housed in a housing, and said optical resonator is fixed on the inner face of said housing, characterized in that a concave portion for suppressing movement of said optical resonator is provided on the inner face of said housing.

16. A wavelength control module according to claim 14, wherein only one of said substrates of the components of said optical resonator is fixed by bonding to said housing and/or said fixing member or said concave portion.

17. A wavelength control module according to claim 14, wherein a resilient member is used as a means for fixing said optical resonator to said housing and/or said fixing member or said concave portion.

18. A wavelength control module according to claim 14, wherein said spacer is formed from a material having a coefficient of linear expansion of almost zero.

19. A wavelength control module according to claim 14, wherein said housing is sealed.

20. A wavelength control module comprising:
an optical resonator obtained by arranging two substrates, whose one face is a reflecting surface having a specified reflectance, parallel with each other, so that said reflecting surfaces face each other with a medium therebetween;
a device which inputs a monitoring optical signal to said optical resonator as parallel light;
a device which detects a change in the intensity of the transmitted light from said optical resonator; and
a condensing device which condenses the transmitted light emitted from said optical resonator to a detection area of said detection device is provided between said optical resonator and said detection device.

21. A wavelength control module according to claim 20, wherein an area of an irradiation area of said transmitted light irradiated to said detection device is smaller than that of said detection area.

22. A wavelength control module according to claim 20, wherein the area of said irradiation area is not larger than ½ of the area of said detection area.

23. A wavelength control module according to claim 20, wherein said condensing device is a condensing lens.

24. A wavelength control module according to claim 20, wherein a focal length of said condensing lens is within a range from 1.8 to 4.0 mm.

25. A wavelength control module which controls an oscillating light source of a monitoring optical signal, so that an intensity of transmitted light of an optical resonator becomes substantially constant, when a monitoring optical signal, whose wavelength is deviated from the central wavelength where transmission of light becomes peak, is input to said optical resonator having a transmission characteristic such that, when the wavelength dependence of light transmission is represented by plotting the transmission on X axis and the wavelength on the Y axis, the wavelength dependence of the transmission shows continuous periodic mountain-shaped distribution, wherein
as the wavelength of said monitoring optical signal, both of a first wavelength which is shorter wavelength side than the central wavelength, and a second wavelength on the longer wavelength side than the central wavelength are used in the wavelength range forming the mountain-shaped distribution.

26. A wavelength control module according to claim 25, wherein an inclination of said graph in said first wavelength and an inclination of said graph in said second wavelength have an opposite sign and an equal absolute value.

27. A wavelength control module according to claim 25, wherein when a wavelength interval between the central wavelength in one mountain-shaped distribution and the central wavelength in another mountain-shaped distribution adjacent thereto is assumed to be ΔP, then the wavelength interval between said first wavelength and said second wavelength is equal to ΔP/2.

28. A wavelength control module according to claim 25 comprising; a device which detects a variation in the intensity of the transmitted light of said optical resonator, and a correction device which reverses a sign with respect to either one of the variation in the intensity of the transmitted light when the wavelength of said monitoring optical signal is said first wavelength, and the variation in the intensity of the transmitted light when the wavelength of said monitoring optical signal is said second wavelength.

29. An optical resonator which shows a graph in which a mountain-shaped distribution of a certain shape is continuous, when the transmission characteristic of the optical resonator is expressed by a graph in which wavelength is plotted on the X axis and transmittance is plotted on the Y axis,
wherein when a wavelength interval between the central wavelength in one mountain-shaped distribution at which the transmittance shows a peak and the central wavelength in another mountain-shaped distribution adjacent thereto is assumed to be ΔP,
then in the wavelength range forming one mountain-shaped distribution, an inclination of said graph in the first wavelength on the shorter wavelength side than the central wavelength, and an inclination of said graph in the second wavelength on the longer wavelength side than said first wavelength by ΔP/2, have an opposite sign but the same absolute value.

30. An optical resonator according to claim 29, wherein the wavelength interval between said first wavelength and said second wavelength in one mountain-shaped distribution corresponds to a full width at half maximum.

31. A wavelength control module comprising:
the optical resonator according to claim 29;
a device which inputs a monitoring optical signal having said first wavelength and a monitoring optical signal having said second wavelength to said optical resonator;
a device which detects a variation in the intensity of transmitted light from said optical resonator;
a correction device which reverses a sign with respect to either one of the variation in the intensity of the transmitted light when the wavelength of said monitoring optical signal is said first wavelength, and the variation in the intensity of the transmitted light when the wavelength of said monitoring optical signal is said second wavelength; and
a device which controls the oscillating light source for said monitoring optical signal so that the detection results obtained through said correction device become substantially constant.

32. An optical resonator wherein two substrates are arranged so as to face each other, with a medium therebetween, and inside end faces of said two substrates have a specified reflectance, respectively, and an outside end face of one substrate has an optical function as a half mirror.

33. An optical resonator according to claim 32, wherein said outside end face of one substrate inclines with respect to the outside end face of the other substrate, and a semitransparent film is formed on said outside end face of one substrate.

34. A wavelength control module comprising:
the optical resonator according to claim 32;
a device which inputs a monitoring optical signal to said outside end face of one substrate in said optical resonator as parallel light;
a first measurement device which measures the intensity of the transmitted light emitted from the outside end face of the other substrate in said optical resonator; and a second measurement device which measures the intensity of the reflected light reflected by said outside end face of one substrate.
